(19) United States
(12) Patent Application Publication
(10) Pub. No.: US 2022/0198421 A1
(43) Pub. Date: Jun. 23, 2022

(54) SERVER DEVICE AND METHOD OF CONTROLLING A SERVER DEVICE

(71) Applicant: TOSHIBA TEC KABUSHIKI KAISHA, Tokyo (JP)

(72) Inventors: Yuko KIMOTO, Shinagawa Tokyo (JP); Sayo SONAGA, Kawasaki Kanagawa (JP); Maki SATO, Yokohama Kanagawa (JP)

(21) Appl. No.: 17/477,467

(22) Filed: Sep. 16, 2021

(30) Foreign Application Priority Data
Dec. 18, 2020 (JP) 2020-210631

(51) Int. Cl. G06Q 20/20; G06Q 10/02; G06Q 50/00; G06Q 30/06; G06Q 20/22; H04L 29/06; H04L 29/08

(52) U.S. Cl. CPC G06Q 20/202; G06Q 10/02; G06Q 50/01; G06Q 30/0633; G06F 3/0482; H04L 65/4015; H04L 65/1069; H04L 65/403; H04L 67/12; G06Q 20/22

(57) ABSTRACT

According to an embodiment, a server device receives access in which participation information is designated from each of terminals provided in a plurality of restaurants. The server device specifies reservation information registered in a reservation management table on the basis of reservation identification information included in the participation information. The server device connects the terminals identified by terminal identification information included in the specified reservation information to each other in a communicable manner.

### CROSS-REFERENCE TO RELATED APPLICATIONS

This application is based upon and claims the benefit of priority from the prior Japanese Patent Application No. 2020-210631, filed on Dec. 18, 2020, the entire contents of which are incorporated herein by reference.

### FIELD

Embodiments described herein generally relate to a server device and a method of controlling a server device.

### BACKGROUND

With the popularization of telework and remote work, web conference systems for carrying out conferences through networks have been widely utilized. Further, the web conference systems have also been used for use applications other than business. For example, drinking parties, social gathering, and the like held using the web conference systems, i.e., remote drinking parties and the like are carried out. Further, for example, when users visit different restaurants and hold a web conference using terminals placed in the restaurants, the users can communicate with the others in other restaurants while eating and drinking food and beverage (menu items) provided by the restaurants.

On the other hand, in the related art, a technique of calculating a payment amount per person on the basis of the number of persons constituting a customer group has been proposed for an order system in a real restaurant.

However, since it is assumed in the related art that an order is performed in the same restaurant, there is no assumption about a mode in which a web conference is performed over a plurality of restaurants as described above. For that reason, for example, even if a remote drinking party is performed in restaurants, the order and checkout of the menu items are performed individually by the user of each restaurant, and there is room for improvement in terms of improvement in convenience.

### BRIEF DESCRIPTION OF THE DRAWINGS

FIG. 1 is a diagram showing a configuration example of a remote eating and drinking proving system according to an embodiment.

FIG. 2 is a diagram showing an example of a hardware configuration of a restaurant terminal according to the embodiment.

FIG. 3 is a diagram showing an example of a hardware configuration of a server device according to the embodiment.

FIG. 4 is a diagram showing an example of a data configuration of a restaurant management table according to the embodiment.

FIG. 5 is a diagram showing an example of a data configuration of a menu management table according to the embodiment.

FIG. 6 is a diagram showing an example of a data configuration of a user management table according to the embodiment.

FIG. 7 is a diagram showing an example of a data configuration of a reservation management table according to the embodiment.

FIG. 8 is a diagram showing an example of a data configuration of an order management table according to the embodiment.

FIG. 9 is a diagram showing an example of a functional configuration of the restaurant terminal and the server device according to the embodiment.

FIG. 10 is a diagram showing an example of a screen displayed on the restaurant terminal according to the embodiment.

FIG. 11 is a diagram showing another example of a screen displayed on the restaurant terminal according to the embodiment.

FIG. 12 is a diagram showing another example of a screen displayed on the restaurant terminal according to the embodiment.

FIG. 13 is a diagram showing another example of a screen displayed on the restaurant terminal according to the embodiment.

FIG. 14 is a diagram showing another example of a screen displayed on the restaurant terminal according to the embodiment.

FIG. 15 is a diagram showing another example of a screen displayed on the restaurant terminal according to the embodiment.

FIG. 16 is a diagram showing another example of a screen displayed on the restaurant terminal according to the embodiment.

FIG. 17 is a diagram showing another example of a screen displayed on the restaurant terminal according to the embodiment.

FIG. 18 is a diagram showing another example of a screen displayed on the restaurant terminal according to the embodiment.

FIG. 19 is a diagram showing another example of a screen displayed on the restaurant terminal according to the embodiment.

FIG. 20 is a diagram showing another example of a screen displayed on the restaurant terminal according to the embodiment.

FIG. 21 is a diagram showing another example of a screen displayed on the restaurant terminal according to the embodiment.

FIG. 22 is a diagram showing another example of a screen displayed on the restaurant terminal according to the embodiment.

FIG. 23 is a diagram showing another example of a screen displayed on the restaurant terminal according to the embodiment.

FIG. 24 is a flowchart showing an example of login processing performed by the server device according to the embodiment.

FIG. 25 is a flowchart showing an example of menu providing processing performed by the server device according to the embodiment.

FIG. 26 is a flowchart showing an example of order processing performed by the server device according to the embodiment.

FIG. 27 is a flowchart showing an example of checkout processing performed by the server device according to the embodiment.

FIG. 28 is a diagram for describing an operation example of the checkout processing performed by a checkout processing unit according to the embodiment.

FIG. 29 is a diagram showing an example of a screen displayed on a restaurant terminal according to a modification of the embodiment.

FIG. 30 is a diagram showing another example of a screen displayed on the restaurant terminal according to the modification of the embodiment.

### DETAILED DESCRIPTION

According to one embodiment, a server device provides a remote eating and drinking service allowing a conversation and screen sharing between users using a plurality of different restaurants. The server device includes a communication device, a reservation management table, and a processor. The communication device communicates with terminals belonging to the plurality of restaurants and operated by the users. The reservation management table registers reservation information in association with reservation identification information. The reservation identification information is information for identifying a reservation for receiving the service. The reservation information includes user identification information for identifying a user who receives the service, restaurant identification information for identifying a restaurant used by the user, and terminal identification information for identifying a terminal belonging to the restaurant used by the user. The processor receives access in which participation information is designated from each of the terminals via the communication device. The participation information includes at least the reservation identification information. The processor specifies the reservation information associated with the reservation identification information included in the participation information from the reservation management table. The processor connects the terminals identified by the terminal identification information included in the specified reservation information to each other in a communicable manner. The processor provides menu information of menu items for eating and drinking that can be provided in the restaurant identified by the restaurant identification information included in the specified reservation information to the connected terminals such that the menu information can be browsed on the connected terminals. Further, the processor receives an order of a menu item for eating and drinking from any one of the terminals provided with the menu information via the communication device and notifies the restaurant that provides the menu item for eating and drinking of information regarding the ordered menu item for eating and drinking.

Hereinafter, embodiments will be described in detail with reference to the drawings. In the drawings, the same reference symbols represent the same or similar parts. Note that the embodiments to be described below are not limited.

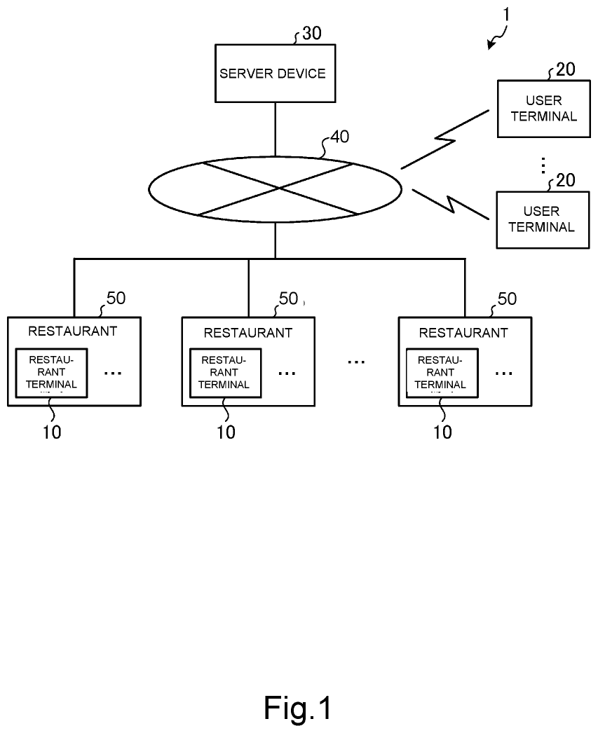

FIG. 1 is a diagram showing a configuration example of a remote eating and drinking proving service system according to an embodiment. As shown in FIG. 1, a remote eating and drinking proving system 1 includes restaurant terminals 10, user terminals 20, and a server device 30. The restaurant terminals 10 and the user terminals 20 are connected to the server device 30 so as to be capable of communicating with each other via a network 40 such as the Internet or a cellular telephone network.

The restaurant terminal 10 is a terminal device provided in each of restaurants 50 that are eating and drinking places such as pubs. The restaurant terminal 10 is, for example, a self-ordering terminal at each seat in the restaurant 50 and is provided by a tablet terminal or the like. Note that the number of restaurant terminals 10 provided in the restaurant 50 is not particularly limited, and a plurality of restaurant terminals 10 may be provided.

Further, each of the restaurants 50 includes a restaurant server (not shown) for receiving the order information provided from the restaurant terminal 10 and the server device 30. Note that each of the restaurants 50 may be an affiliated restaurant such as a chain restaurant, or may be an independent restaurant.

The user terminal 20 is a terminal device used by a user who uses the remote eating and drinking proving system 1. The user terminal 20 can be provided by a portable terminal device such as a smart phone or a tablet terminal.

The server device 30 is an example of the server device of this embodiment. The server device 30 is provided by an information processing apparatus such as a workstation. Note that the server device 30 is described as a single device in this embodiment, but the server device 30 is not limited thereto. For example, the server device 30 may implement the functions thereof that are dispersed among a plurality of server devices.

The server device 30 cooperates with the restaurant terminal 10 of each restaurant 50 to provide a remote eating and drinking proving service using the restaurant terminal 10. More specifically, the server device 30 provides a service (remote eating and drinking proving service) allowing a conversation and screen sharing between users of different restaurants 50 by controlling communication between the restaurant terminals 10 provided in the plurality of restaurants 50. Hereinafter, the remote eating and drinking proving service using the restaurant terminals 10, or performing (enjoying) the remote eating and drinking proving service using the restaurant terminals 10 will also be referred to as a “remote drinking party”.

Next, the configuration of the main device of the remote eating and drinking proving system 1 will be described.

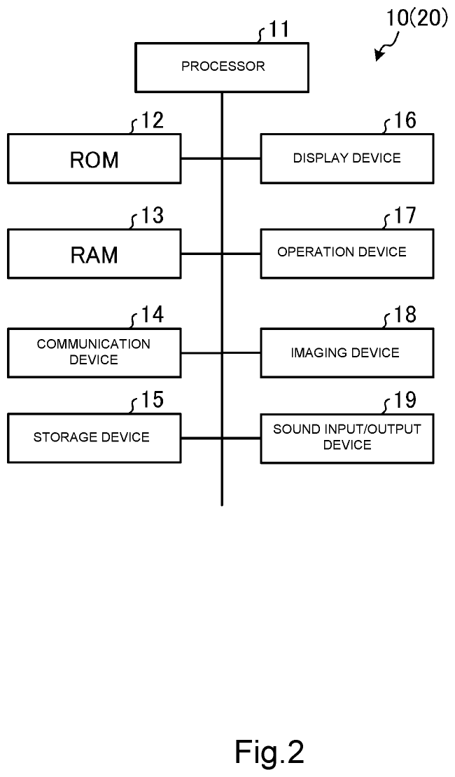

FIG. 2 is a diagram showing an example of a hardware configuration of the restaurant terminal 10. As shown in FIG. 2, the restaurant terminal 10 has a computer configuration including a processor 11, a read only memory (ROM) 12, a random access memory (RAM) 13, and the like. The processor 11 is, for example, a central processing circuit (CPU).

The processor 11 collectively controls each unit of the restaurant terminal 10. The ROM 12 stores various programs. The RAM 13 is used as a workspace for developing programs and various types of data.

Further, the restaurant terminal 10 includes a communication device 14, a storage device 15, a display device 16, an operation device 17, an imaging device 18, and a sound input/output device 19.

The communication device 14 is a communication interface connectable to the network 40. The communication device 14 communicates with an external device such as the server device 30 through the network 40. Further, the communication device 14 communicates with the restaurant server in its restaurant and with other restaurant terminals 10.

The storage device 15 is a storage medium such as a hard disk drive (HDD) or a flash memory and maintains stored contents even when the power is turned off. The storage device 15 stores programs that can be executed by the processor 11, and various types of set information. For example, the storage device 15 stores a program (client program) prepared for a remote drinking party, content regarding the display of graphical user interfaces (GUIs), and the like. The processor 11 operates in accordance with the programs stored in the ROM 12 and the storage device 15 and deployed in the RAM 13 to perform various types of processing.

The display device 16 is a display device such as a liquid crystal display (LCD) and displays a screen including various types of information under the control of the processor 11. The operation device 17 includes various operation keys and outputs the operation contents corresponding to a user's operation to the processor 11. Note that the operation device 17 may be a touch panel provided on the surface of the display device 16.

The imaging device 18 includes an image pickup device such as a charge coupled device (CCD). The imaging device 18 captures, for example, an image of the user who operates the restaurant terminal 10, and thus acquires image data of the user (still image, moving image) and outputs the acquired image data to the processor 11.

The sound input/output device 19 includes a sound input unit such as a microphone and a sound output unit such as a speaker. The sound input/output device 19 acquires voice data of the user and outputs the acquired voice data to the processor 11. Further, the sound input/output device 19 outputs, as a sound, sound data input from the processor 11.

Note that the hardware configuration of the restaurant terminal 10 is not limited to the configuration shown in FIG. 2. Further, the user terminal 20 has a hardware configuration similar to that of the restaurant terminal 10.

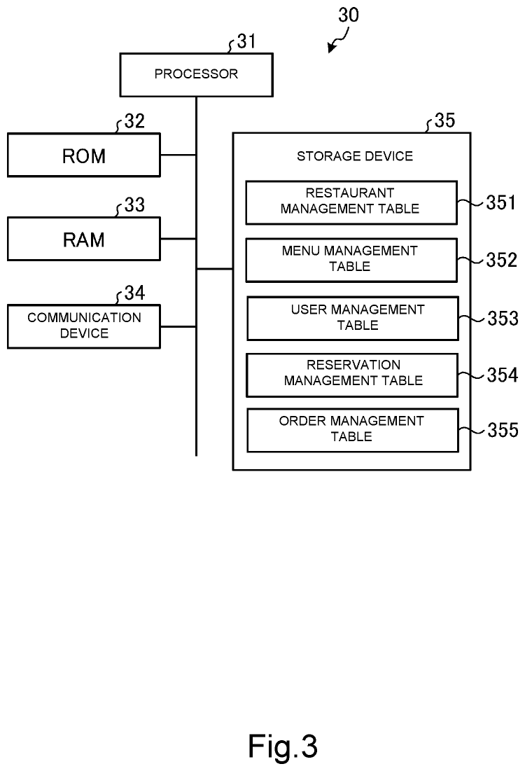

FIG. 3 is a diagram showing an example of a hardware configuration of the server device 30. As shown in FIG. 3, the server device 30 has a computer configuration including a processor 31, a ROM 32, a RAM 33, and the like. The processor 31 is, for example, a CPU.

The processor 31 collectively controls each unit of the server device 30. The ROM 32 stores various programs. The RAM 33 is used as a workspace for developing programs and various types of data.

The server device 30 also includes a communication device 34 and a storage device 35. The communication device 34 is a communication interface connectable to the network 40. The communication device 34 communicates with external devices such as the restaurant terminal 10 and the user terminal 20 through the network 40.

The storage device 35 is a storage medium such as an HDD or a flash memory and maintains stored contents even when the power is turned off. The storage device 35 stores programs that can be executed by the processor 31, and various types of set information. For example, the storage device 35 stores programs (server programs) prepared for a remote drinking party, content regarding the display of GUIs, and the like. The processor 31 operates in accordance with the programs stored in the ROM 32 and the storage device 35 and deployed in the RAM 33 to perform various types of processing.

Further, the storage device 35 stores a restaurant management table 351, a menu management table 352, a user management table 353, a reservation management table 354, and an order management table 355.

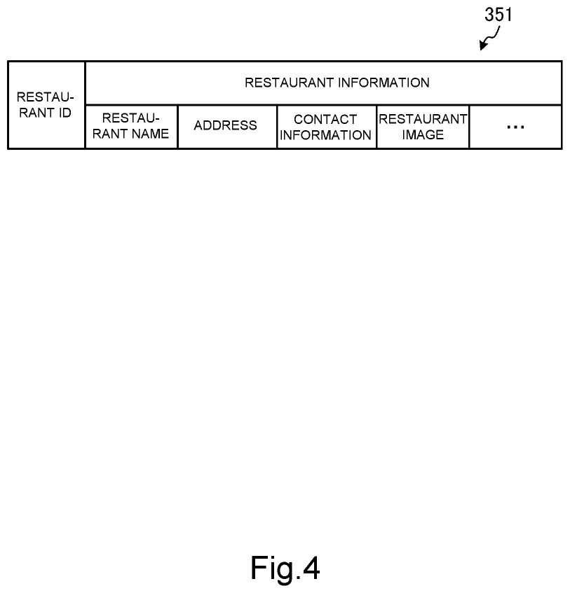

FIG. 4 is a diagram showing an example of a data configuration of the restaurant management table 351. As shown in FIG. 4, the restaurant management table 351 stores restaurant information regarding a restaurant 50 corresponding to a restaurant ID in association with a restaurant ID of each restaurant 50.

The restaurant ID is identification information for identifying each restaurant 50. The restaurant information includes items such as a restaurant name, an address, contact information, and a restaurant image of the restaurant 50. The restaurant name is a trade name of the restaurant 50, the name of a branch, or the like. The address means an address indicating the location of the restaurant 50. The contact information means, for example, address information such as an address and an IP address of the restaurant 50. The restaurant image is image information such as an icon and a logo mark representing the restaurant 50 corresponding to the restaurant ID. Note that the data configuration of the restaurant management table 351 is not limited to the example shown in FIG. 4.

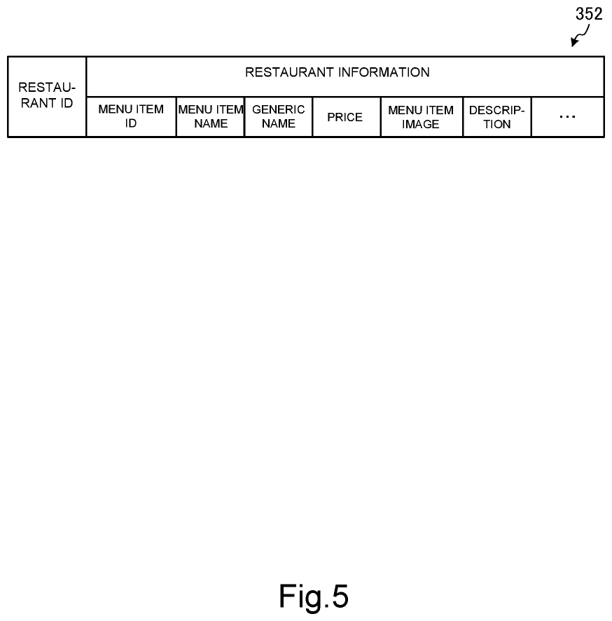

FIG. 5 is a diagram showing an example of a data configuration of the menu management table 352. As shown in FIG. 5, the menu management table 352 stores menu information regarding each menu item (menu) that can be served in the restaurant 50 corresponding to the restaurant ID in association with the restaurant ID of each restaurant 50. For example, the server device 30 acquires menu information from the restaurant server or the like of each restaurant 50 and stores the menu information in the menu management table 352.

The menu information includes, for example, a menu item ID, a menu item name, a generic name, a price, a menu item image, a description, and the like of the menu item (menu).

The menu item ID is identification information for identifying a menu item provided in each restaurant 50. The menu item name is information indicating a menu item name (item, formal name, etc.) of a menu item corresponding to the menu item ID. The generic name is information indicating a generic name, an abbreviation, and a given name of the menu item name. For example, it is assumed that “beer” provided in a restaurant 50A are “50A beer large” and “50A beer medium”, and the name of “beer” provided in a restaurant 50B is “50B beer”. In this case, the menu item IDs and the menu item names respectively indicating “50A beer large” and “50A beer medium” are registered in association with the restaurant ID of the restaurant 50A, and the generic name “beer” is registered in association with each of those menu item IDs. Further, the menu item ID and the menu item name indicating “50B beer” are registered in association with the restaurant ID of the restaurant 50B, and the generic name “beer” is registered in association with that menu item ID.

The price is information indicating the unit price of the menu item corresponding to the menu item ID. The menu item image is image data (menu item image) such as photographs and illustrations representing the menu item corresponding to the menu item ID. The description is information indicating a description text of the menu item corresponding to the menu item ID, an estimated time required for cooking, a degree of popularity in the restaurant 50 corresponding to the restaurant ID, and the like.

Note that the data configuration of the menu management table 352 is not limited to the example of FIG. 5. Further, the server device 30 may be configured to update the menu information at a predetermined timing by periodically or as needed acquiring the menu information of the menu management table 352 from the restaurant server or the like of each restaurant 50.

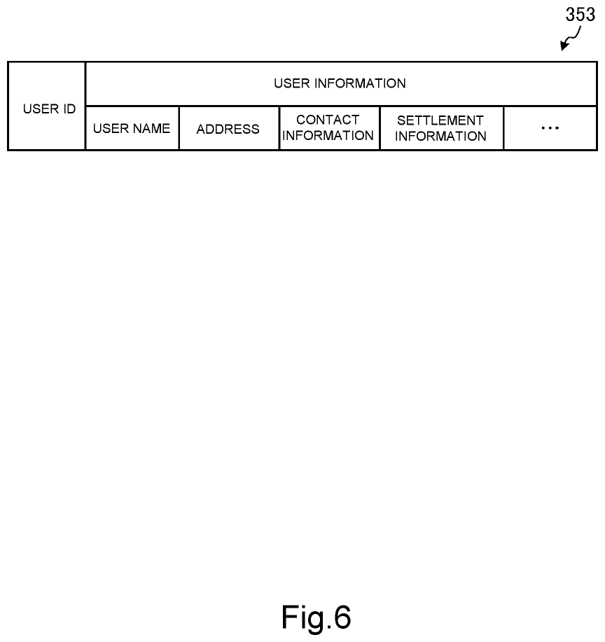

FIG. 6 is a diagram showing an example of a data configuration of the user management table 353. As shown in FIG. 6, the user management table 353 stores user information regarding the user corresponding to the user ID in association with the user ID of each user. Here, the user ID is identification information for identifying each user.

The user information includes, for example, a user name, an address, contact information, and settlement information. The user name is information indicating the name of the user corresponding to the user ID. The address is information indicating the address, the residence, or the like of the user corresponding to the user ID. The contact information is information indicating the contact information of the user corresponding to the user ID. In the contact information, the identification information such as a telephone number or a terminal ID of the user terminal 20 owned by the user is registered. The settlement information is information regarding electronic settlement such as credit card settlement or electronic money settlement. The settlement information holds one or more pieces of information such as a credit card number and is used when the price of a menu item is paid by the electronic settlement.

Note that the data configuration of the user management table 353 is not limited to the example of FIG. 6. For example, the user management table 353 may store information such as the gender, age, preference, or the like of the user corresponding to the user ID in association with the user ID of each user.

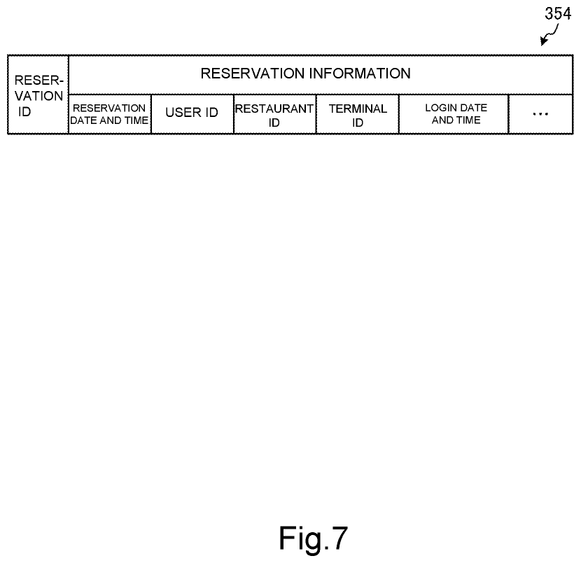

FIG. 7 is a diagram showing an example of a data configuration of the reservation management table 354. As shown in FIG. 7, the reservation management table 354 stores reservation information regarding the reservation ID in association with the reservation ID.

Here, the reservation ID is identification information for identifying a use reservation for a remote drinking party. The server device 30 issues a unique reservation ID (e.g., a number in ascending order) each time a use reservation for the remote drinking party is received from the user through the user terminal 20 or the like.

The reservation information includes, for example, information such as reservation date and time, the user ID, the restaurant ID, the terminal ID, and login date and time.

The reservation date and time is information indicating the date and time at which a remote drinking party is scheduled to be held. The reservation date and time is represented by, for example, a period between starting date and time and ending date and time.

The user ID of a user who participates in the remote drinking party is registered for the user ID. Each of the reservation IDs can be associated with one or more user IDs, and the user IDs associated with the same reservation ID are managed as a group to participate in the same remote drinking party. In other words, the reservation ID also serves as an identifier for identifying each group. Hereinafter, the user IDs associated with the same reservation ID or users corresponding to that user IDs will be referred to as users belonging to the same group, for example.

The identification information of the restaurant terminal 10 to be used in the remote drinking party is registered for the terminal ID. In addition, the date and time at which the use of the restaurant terminal 10 corresponding to the terminal ID is started is registered for the login date and time.

In this embodiment, it is assumed that the reservation date and time, the user ID, and the restaurant ID among the information included in the reservation information are registered before the remote drinking party is held. Further, it is assumed that the terminal ID and the login date and time among the information included in the reservation information are registered on the day on which the remote drinking party is held, that is, when the user corresponding to the user ID visits the restaurant 50. Note that the restaurant ID of the restaurant 50 may be registered for the restaurant ID when the user visits the restaurant 50 on the day on which the remote drinking party is held. Alternatively, the user and the restaurant 50 that the user visits may be registered in association with each other. For example, the restaurant ID may be registered in advance in association with the user ID registered in the reservation information of the reservation ID.

Note that the data configuration of the reservation management table 354 is not limited to the example of FIG. 7. For example, the reservation management table 354 may store information indicating the name, description, or the like of the remote drinking party in association with the reservation ID. In addition, the reservation management table 354 may store information indicating the organizer, manager, or the like of the remote drinking party in association with the user ID.

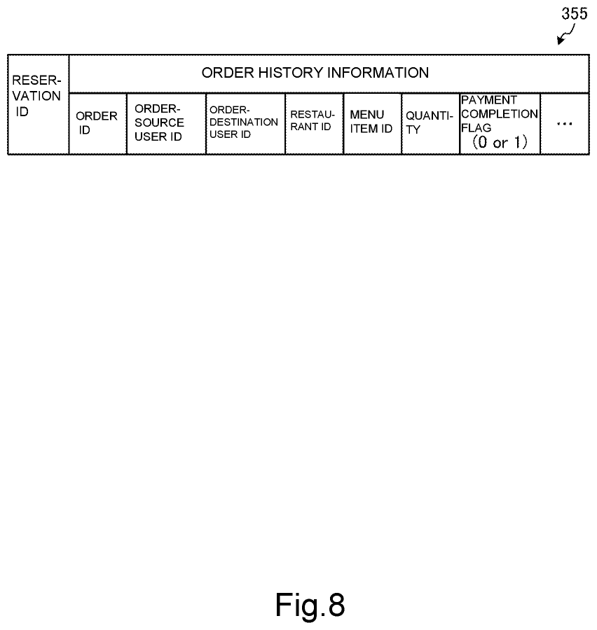

FIG. 8 is a diagram showing an example of a data configuration of the order management table 355. As shown in FIG. 8, the order management table 355 stores order history information regarding the menu items ordered in the remote drinking party corresponding to the reservation ID in association with the reservation ID.

The order history information includes information such as an order ID, an order-source user ID, an order-destination user ID, the restaurant ID, the menu item ID, quantity, and a payment completion flag.

Here, the order ID is identification information for identifying each order. The server device 30 issues a unique order ID (e.g., a number in an ascending order) each time the order of a menu item is received from the user (restaurant terminal 10).

The user ID of the user who orders the menu item is registered for the order-source user ID. The user ID of the user to whom the ordered menu item is provided is registered for the order-destination user ID. For example, when a user orders a menu item to eat and drink for himself/herself, the same user ID is registered for the order-source user ID and the order-destination user ID. Further, for example, when a user orders a menu item to eat and drink for another user, different user IDs are registered for the order-source user ID and the order-destination user ID.

The order-destination restaurant ID is registered for the restaurant ID. In other words, the restaurant ID of the restaurant 50 in which the order-destination user ID is present is registered for the restaurant ID. The menu item ID of an ordered menu item is registered for the menu item ID. The quantity of the ordered menu item is registered for the quantity.

In addition, flag information indicating whether or not the payment for the ordered menu item has been made is registered for the payment completion flag. In this embodiment, as will be described later, when a certain user gives another user a menu item as a gift (hereinafter, this order method will also be referred to as “treat order” or the like), the payment for the menu item is configured to be performed first. Specifically, when the order-source user ID and the order-destination user ID are different from each other and the user corresponding to the order-source user ID pays for the menu item, a flag indicating that the payment has been made is registered for the payment completion flag. In other words, the payment completion flag is also an index indicating whether or not the treat order has been performed. FIG. 8 shows a case where the flag “0” is set when the payment has not been made, and the flag “1” is set when the payment has been made.

Note that the data configuration of the order management table 355 is not limited to the example of FIG. 8. For example, the order management table 355 may store information indicating the date and time at which the order is performed.

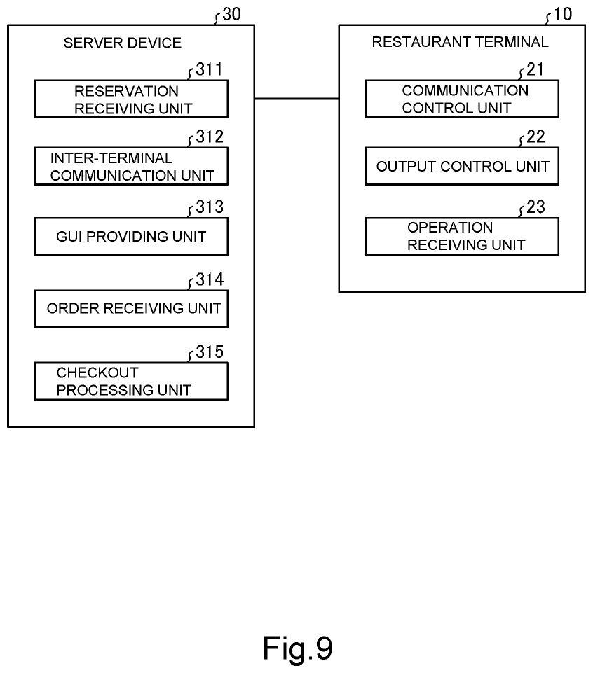

Next, the functional configurations of the restaurant terminal 10 and the server device 30 will be described with reference to FIG. 9. FIG. 9 is a diagram showing an example of the functional configurations of the restaurant terminal 10 and the server device 30.

As shown in FIG. 9, the processor 11 of the restaurant terminal 10 includes a communication control unit 21, an output control unit 22, and an operation receiving unit 23 as functional units.

Part or all of the functional units of the processor 11 of the restaurant terminal 10 may be a software configuration implemented by cooperation between the processor 11 (e.g., the CPU) and a program stored in the memory (e.g., the ROM 12, the storage device 15). Further, part or all of the functional units of the restaurant terminal 10 may have a hardware configuration implemented by a dedicated circuit or the like mounted on the restaurant terminal 10.

The communication control unit 21 of the processor 11 of the restaurant terminal 10 controls the communication device 14 to exchange various kinds of information (data) with the server device 30 and the restaurant server. For example, the communication control unit 21 transmits the image data and sound data acquired by the imaging device 18 and the sound input/output device 19 to the server device 30. Further, for example, the communication control unit 21 receives the image data and sound data transmitted from another restaurant terminal 10 through the server device 30.

The output control unit 22 of the processor 11 controls the display device 16 and the sound input/output device 19 to output various types of information (data). For example, the output control unit 22 causes the display device 16 to display the image data acquired by the imaging device 18 and the image data transmitted from another restaurant terminal 10. Further, the output control unit 22 cooperates with the server device 30 to cause the display device 16 to display various graphical user interfaces (GUIs). In addition, the output control unit 22 causes the sound input/output device to output the sound data acquired by the sound input/output device 19 and the sound data transmitted from another restaurant terminal 10.

The operation receiving unit 23 of the processor 11 receives the contents of the user's operation input via the operation device 17. For example, the operation receiving unit 23 receives an operation for the GUI displayed on the display device 16. Note that the restaurant terminal 10 functions as an input/output interface of the server device 30 in this embodiment.

Meanwhile, the processor 31 of the server device 30 operates as functional units including a reservation receiving unit 311, an inter-terminal communication unit 312, a GUI providing unit 313, an order receiving unit 314, and a checkout processing unit 315.

Part or all of the functional units of the processor 31 of the server device 30 may be a software configuration implemented by cooperation between the processor 31 (e.g., the CPU) and a program stored in the memory (e.g., the ROM 32, the storage device 35). Further, part or all of the functional units included in the server device 30 may have a hardware configuration implemented by a dedicated circuit or the like mounted on the server device 30.

The reservation receiving unit 311 of the processor 31 receives a use reservation for a remote drinking party, and registers the contents of the received reservation in the reservation management table 354 (see FIG. 7). The method of receiving the reservation is not particularly limited, and various methods can be employed.

For example, the following mode may be adopted: a web site in which the date and time at which a remote drinking party is held and a restaurant to be used can be designated is opened on the network 40, and a reservation is received via the web site. In this case, a user who is the organizer or manager (hereinafter, referred to as manager) accesses the web site using the user terminal 20. The manager makes a reservation (new reservation) for a remote drinking party by inputting the date and time at which the remote drinking party is held, the user ID of the manager, the restaurant 50 (restaurant ID) to be used by the manager, and the like on the accessed web site. Upon receiving the new reservation, the reservation receiving unit 311 issues a reservation ID and registers it in the reservation management table 354 (see FIG. 7) together with the input matters. Further, the reservation receiving unit 311 notifies the user terminal 20 of the user of the issued reservation ID. The manager then notifies other users who are members of the remote drinking party of the user ID. When a new reservation is made, the user ID of another user other than the manager may be input.

On the other hand, another user who receives the notification of the reservation ID accesses the above-mentioned web site with the designated reservation ID, by using his/her own terminal 20. Upon receiving the access in which the reservation ID is designated, the reservation receiving unit 311 reads the reservation information corresponding to the reservation ID (the date and time, etc.) from the reservation management table 354 (see FIG. 7) and provides the reservation information to the user terminal 20 of the access source so as to be viewable. The other user makes a reservation (additional reservation) for the remote drinking party by inputting his/her own user ID, a restaurant (restaurant ID) to be used by himself/herself, and the like. Upon receiving the additional reservation, the reservation receiving unit 311 additionally registers the additional reservation matters in the reservation information of the reservation ID input in advance.

Note that the reservation receiving unit 311 of the processor 31 may be configured to compare the address stored in the user information with the addresses stored in the restaurant information of the restaurants 50 and to present, as use candidates, the restaurants 50 existing within a predetermined range (e.g., within 3 Km) from the user's address to the user.

Through the above-mentioned processing (reservation processing), the reservation receiving unit 311 of the processor 31 registers the set of the user ID of each of the users who participate in the same remote drinking party, and the restaurant ID used by each user, in the reservation management table 354 (see FIG. 7) in association with the common reservation ID. Note that, in the above description, another user who has received the notification of the reservation ID additionally registers his or her own user ID or the like in the reservation information of the reservation ID by himself/herself, but this embodiment is not limited thereto. For example, if a representative acquires the user ID of a participant in advance, the representative may register the user ID of the participant collectively. Further, after the reservation processing is completed, the user terminal 20 of the user who has completed the registration of the user ID may acquire two-dimensional code information in which the reservation ID and the user ID are associated with each other, or link information for displaying the two-dimensional code information. For example, login processing may be performed when the user terminal 20 displays the two-dimensional code information and the restaurant terminal 10 reads the displayed two-dimensional code information on the day for which the reservation has been made.

The inter-terminal communication unit 312 of the processor 31 functions as an example of a management means together with the reservation receiving unit 311. The inter-terminal communication unit 312 receives access from the restaurant terminal 10 of the restaurant 50 and manages the restaurant 50 (restaurant ID) and the restaurant terminal 10 (terminal ID) of the access source in association with a user (user ID) who operates the restaurant terminal 10.

Further, the inter-terminal communication unit 312 is an example of a communication control means. The inter-terminal communication unit 312 connects the restaurant terminals 10 of the users associated with the same reservation ID, that is, the users belonging to the same group so as to be communicable with each other.

Specifically, upon receiving the access in which the participation information such as the reservation ID and the user ID is designated from the restaurant terminal 10, the inter-terminal communication unit 312 specifies the reservation information corresponding to the designated reservation ID from the reservation management table 354 (see FIG. 7). The inter-terminal communication unit 312 performs login processing for determining whether or not the designated user ID is included in the specified reservation information. When the designated user ID is included in the reservation information, the inter-terminal communication unit 312 additionally registers the terminal ID of the restaurant terminal 10 of the access source and the current date and time (login date and time) in the reservation information in association with the user ID.

When the terminal ID and the login date and time are registered in the reservation information, the inter-terminal communication unit 312 performs control for connecting the restaurant terminals 10 with the terminals ID registered in the reservation information to be communicable with each other. As a result, data can be shared between the restaurant terminals 10 associated with the same reservation ID, so that the users belonging to the same group can have a conversation with each other while viewing the images (face images) captured by the respective restaurant terminals 10.

Note that the inter-terminal communication unit 312 may be configured to register the terminal ID of the restaurant terminal 10 and the restaurant ID of the restaurant 50 to which the restaurant terminal 10 belongs in the reservation information at the time of the access from the restaurant terminal 10.

Further, if the user ID received from the restaurant terminal 10 is not included in the reservation information of the corresponding reservation ID, the inter-terminal communication unit 312 may be configured to deny access or to additionally register the user ID in the reservation information.

The GUI providing unit 313 of the processor 31 is an example of a providing means. The GUI providing unit 313 provides various kinds of GUIs to the restaurant terminal 10. Specifically, the GUI providing unit 313 provides the restaurant terminal 10 with information for displaying a screen on which the restaurant terminals 10 can browse menu information representing menu items that can be provided in the restaurant 50 to which the restaurant terminal 10 belongs. In addition, the GUI providing unit 313 provides a screen for ordering menu items, a screen for checkout, and the like to each of the restaurant terminals 10. Various operation screens provided by the GUI providing unit 313 will be described later.

The order receiving unit 314 of the processor 31 is an example of an order receiving means. The order receiving unit 314 receives the order of a menu item from any one of the restaurant terminals 10 to which the menu information is provided, and notifies the restaurant 50, which provides the menu item, of information on the ordered menu item (order information).

Further, each time the order of a menu item is received, the order receiving unit 314 specifies the user ID (order-source user ID) of the user of the restaurant terminal 10 that has made the order, and the user ID (order-destination user ID) of the user of the restaurant 50 to which the ordered menu item is to be provided. Under the reservation ID corresponding to the specified user ID, the order receiving unit 314 registers, as the order history information, the information such as the specified user ID, the restaurant ID of the order destination, and the menu item ID in the order management table 355 (see FIG. 8) in association with the newly issued order ID.

The checkout processing unit 315 of the processor 31 is an example of a checkout means. The checkout processing unit 315 performs checkout processing for paying for the menu item received by the order receiving unit 314 to the restaurant 50 that provides the menu item. Specifically, the checkout processing unit 315 performs checkout processing for paying for the ordered menu item by using the settlement information stored in the user management table 353 (see FIG. 6).

Note that the payment for the menu item is not limited to the method using the settlement information. For example, the payment for the menu item may be made by other payment methods such as code settlement using two-dimensional code information or the like, or cash settlement. In this case, the checkout processing unit 315 determines that the payment by the user has been completed on condition that information indicating that the payment for the menu item has been completed is received together with the user ID from the device such as the user terminal 20 or the restaurant server.

The operation of the processor 31 of the server device 30 will be described below. Note that the GUI providing unit 313 of the processor 31 of the server device 30 provides information for causing the restaurant terminal 10 to display a screen to the restaurant terminal 10. The processor 31 performs various types of processing in accordance with the user's operation on the screen. Thus, the operation of the server device 30 will be described below on the basis of the screen displayed on the display device 16 of the restaurant terminal 10. It is assumed that the reservation for a remote drinking party has been made in advance.

First, when receiving access in which a reservation ID and a user ID are designated from the restaurant terminal 10, the inter-terminal communication unit 312 of the processor 31 specifies the reservation information by executing the above-mentioned login processing. Note that the login processing may be performed as follows: a code reader (not shown) of the restaurant terminal reads the two-dimensional code information displayed by the user terminal 20 to acquire the reservation ID and the user ID associated with the two-dimensional code information, so that the reservation information is specified. Further, the inter-terminal communication unit 312 registers the terminal ID and the login date and time of the restaurant terminal 10 of the access source in the specified reservation information (reservation management table 354) (see FIG. 7).

Next, the inter-terminal communication unit 312 of the processor 31 compares the reservation date and time included in the reservation information with the current date and time, and determines whether or not the starting date and time of the remote drinking party has come.

Here, if determining that the starting date and time has not come, the inter-terminal communication unit 312 cooperates with the GUI providing unit 313 to cause the display device 16 of the restaurant terminal 10 to display a standby screen (not shown) for indicating that the starting date and time has not come. In such a standby screen, for example, the countdown to the starting date and time may be displayed.

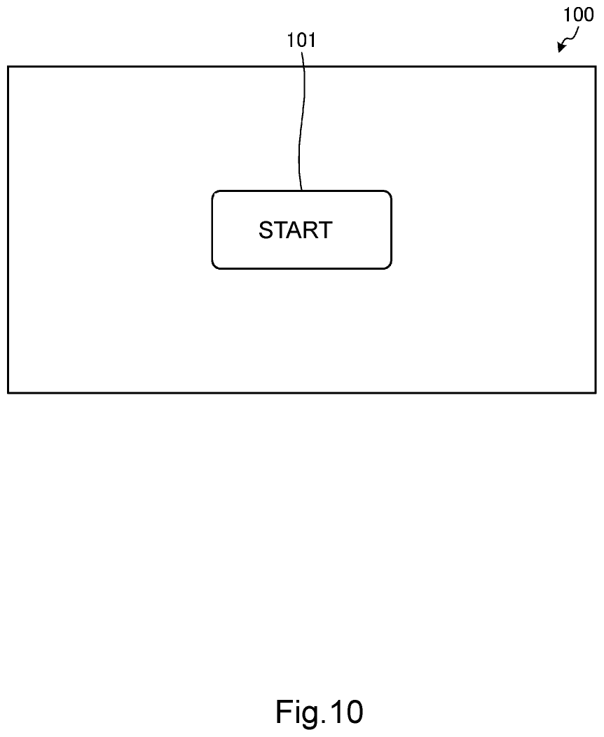

Further, if determining that the starting date and time has come or passed, the inter-terminal communication unit 312 cooperates with the GUI providing unit 313 to cause the display device 16 of the restaurant terminal 10 to display a start screen (see FIG. 10) capable of instructing the start of the remote drinking party.

FIG. 10 is a diagram showing an example of a screen displayed on the restaurant terminal 10. Here, FIG. 10 shows a display example of the start screen. As shown in FIG. 10, a start screen 100 includes a start button 101 that is an operating element for instructing the start of the remote drinking party.

Upon receiving the operation of the start button 101 from the start screen 100 of the restaurant terminal 10, the inter-terminal communication unit 312 of the processor 31 establishes communication between the restaurant terminals 10 of the terminals ID registered in the reservation information, and provides a state where data can be shared between the restaurant terminals 10.

Further, upon receiving the operation of the start button 101 from the start screen 100 of the restaurant terminal 10, the GUI providing unit 313 of the processor 31 causes the display device 16 of the restaurant terminal 10 to display a main screen 110 for displaying data (image data) shared between the restaurant terminals 10.

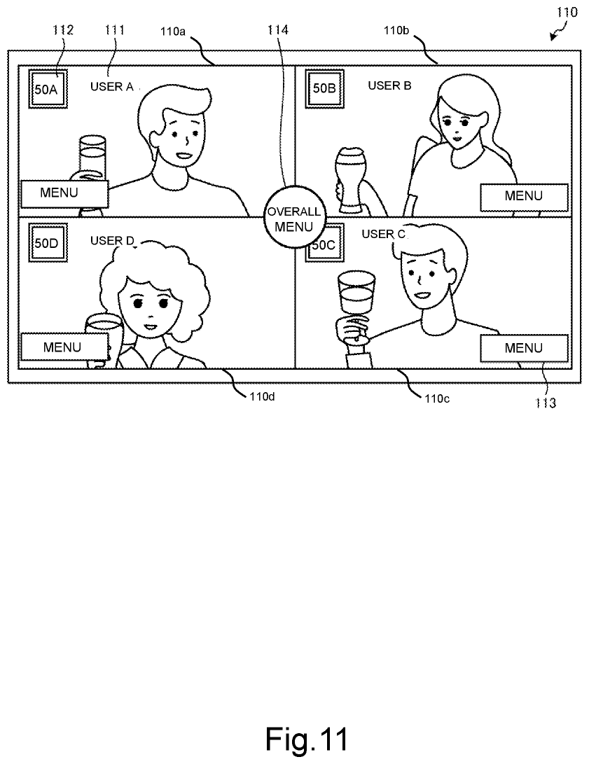

FIG. 11 is a diagram showing another example of a screen displayed on the restaurant terminal 10. FIG. 11 shows a display example of the main screen 110. As shown in FIG. 11, the main screen 110 includes a plurality of sub-screens 110a, 110b, 110c, and 110d divided according to the number of participants in the remote drinking party. FIG. 11 shows an example in which the main screen 110 is divided into four sub-screens 110a to 110d corresponding to four users A, B, C, and D.

Each of the sub-screens 110a to 110d is associated with a terminal ID of a restaurant terminal 10 operated by a corresponding one of the users A to D, a user ID of the user operating the restaurant terminal 10, a restaurant ID of a restaurant 50 to which the restaurant terminal 10 belongs, and the like. Further, on each of the sub-screens 110a to 110d, image data acquired (captured) by the restaurant terminal 10 of a corresponding terminal ID is displayed. Further, sound data acquired by the restaurant terminal 10 is provided from the server device 30 to each of the restaurant terminals 10. In the restaurant terminal 10, the sound data is output as a sound from the sound input/output device 19 by the output control unit 22 of the processor 11.

As a result, the user of the restaurant terminal 10 can have a conversation with the participants of the remote drinking party while facing each other by viewing the main screen 110.

Further, in each of the sub-screens 110a to 110d, a user name 111 of a user ID associated with the sub-screen and a restaurant image 112 of the restaurant 50 are displayed. Specifically, the GUI providing unit 313 of the processor 31 reads a user name corresponding to the user ID from the user management table 353 (see FIG. 6). Further, the GUI providing unit 313 reads a restaurant image of the restaurant from the restaurant management table 351 (see FIG. 4). The GUI providing unit 313 then superimposes and displays the read user name and restaurant image, as the user name 111 and the restaurant image 112, on each of the sub-screens 110a to 110d.

FIG. 11 shows an example in which the user name of “user A” and the restaurant image 112 of a restaurant 50A used by the user A are displayed on the upper left sub-screen 110a. Further, FIG. 11 shows an example in which the user name of “user B” and the restaurant image 112 of a restaurant 50B used by the user B are displayed on the upper right sub-screen 110b. FIG. 11 shows an example in which the user name of “user C” and the restaurant image 112 of a restaurant 50C used by the user C are displayed on the lower right sub-screen 110c. FIG. 11 shows an example in which the user name of “user D” and the restaurant images 112 of a restaurant 50D used by the user D are displayed on the lower left sub-screen 110d.

Thus, by viewing the main screen 110, the user of the restaurant terminal 10 can easily confirm the user name of each user who participates in the remote drinking party and the restaurant 50 used by each user. Note that, in this embodiment, a GUI screen operated by the user C on the restaurant terminal 10 of the restaurant 50C will be exemplified. Further, the main screen 110 may be set to display images other than the image of the user who operates the restaurant terminal 10.

Further, each of the sub-screens 110a to 110d is provided with a menu button 113 for instructing display of a menu of each restaurant 50. When receiving the operation of the menu button 113 from the restaurant terminal 10, the GUI providing unit 313 of the processor 31 reads the menu information from the menu management table 352 (see FIG. 5) on the basis of the restaurant ID of the restaurant 50 corresponding to the sub screen on which the menu button 113 is provided. The GUI providing unit 313 then causes the display device 16 of the restaurant terminal 10 of the operation source to display a menu screen 120 based on the read menu information.

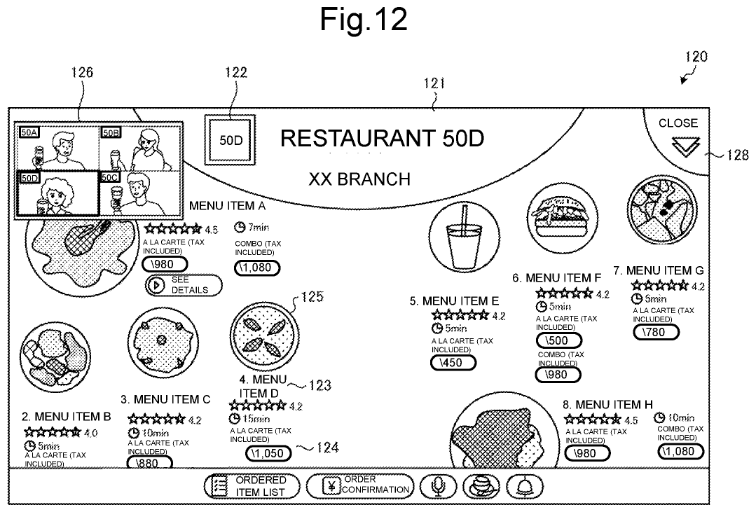

FIG. 12 is a diagram showing another example of a screen displayed on the restaurant terminal 10. FIG. 12 shows a display example of the menu screen 120. As shown in FIG. 12, a restaurant name 121 and a restaurant image 122 of the restaurant 50 corresponding to the operated menu button 113 are displayed on the menu screen 120. Further, information such as a menu item name 123, a price 124, and a menu item image 125 of each menu item included in the menu information is displayed on the menu screen 120. A reduced screen 126 obtained by reducing the size of the main screen 110 of FIG. 11 is superimposed and displayed on the menu screen 120. Thus, the user can continue a conversation with the other users while viewing and operating the menu screen 120. The size and display position of the reduced screen 126 are not limited to those in FIG. 12 and can be arbitrarily adjusted.

In such a manner, in response to the operation of the menu button 113 displayed on each of the sub-screens 110a to 110d, the GUI providing unit 313 of the processor 31 causes the display device 16 of the restaurant terminal 10 of the operation source to display the menu information (menu screen) showing menu items that can be provided in the restaurant 50 corresponding to the operated menu button 113. Thus, the GUI providing unit 313 can provide the menu screen of the restaurant to which the restaurant terminal 10 belongs, so that the menu screen can be browsed between the restaurant terminals 10 of the same group.

Further, in the menu screen 120, the menu item name 123, the price 124, and the menu item image 125 of each menu item function as operating elements for receiving the order of the menu item. Specifically, the menu item name 123, the price 124, and the menu item image 125 are associated with the menu item ID of the corresponding menu item, the restaurant ID of the restaurant 50 that provides the menu item, and the like. When the menu item is selected, the server device 30 is notified of the terminal ID of the restaurant terminal 10 and the user ID of the user who operates the restaurant terminal together with the menu item ID and the restaurant ID associated with the selected menu item. When receiving the selection operation of the menu item from the restaurant terminal 10, the order receiving unit 314 of the processor 31 performs the processing regarding the order of the selected menu item.

Here, the order receiving unit 314 of the processor 31 determines whether or not the user ID of the user who has performed the selection operation with the restaurant terminal 10, that is, the order-source user, matches the user ID of the user of the restaurant 50 that provides the selected menu item, that is, the order-destination user.

If both the user IDs match with each other, the order receiving unit 314 of the processor 31 determines that the user has ordered the menu item to eat and drink for himself/herself. In this case, the order receiving unit 314 notifies the restaurant server of the restaurant 50, which corresponds to the order-destination restaurant ID, of the order information including the menu item ID of the ordered menu item, the user ID of the order-destination user, the terminal ID of the restaurant terminal 10 operated by the user, and the like.

Further, the order receiving unit 314 of the processor 31 registers the order history information, in which the user ID of the user who has performed the selection operation is set for the order-source user ID and the order-destination user ID in association with a newly issued order ID, in the order management table 355 (see FIG. 8). Further, the order receiving unit 314 registers the order-destination restaurant ID, the menu item ID of the ordered menu item, the number of pieces, and the like in the order history information. It is assumed that “0” indicating that the payment has not been made is set for the payment completion flag by default.

On the other hand, if both of the user IDs are different from each other, the order receiving unit 314 of the processor 31 determines that the order-source user has ordered the menu item for another user to eat and drink. In this case, the order receiving unit 314 cooperates with the GUI providing unit 313 to cause the display device 16 of the restaurant terminal 10, which is operated by the order-source user, to display a confirmation screen (not shown) for confirming whether or not the order is a “treat order” in which the price of the ordered menu item is paid by the order-source user.

Here, if it is indicated from the restaurant terminal 10 that the order is not a “treat order”, the order receiving unit 314 of the processor 31 notifies the restaurant server of the restaurant 50, which corresponds to the order-destination restaurant ID, of the order information including the menu item ID of the ordered menu item, the user ID of the order-destination user, the terminal ID of the restaurant terminal 10 operated by that user, and the like.

The order receiving unit 314 of the processor 31 then registers the order history information, in which the order-source user ID and the order-destination user ID different from each other are set in association with a newly issued order ID, in the order management table 355 (see FIG. 8). Further, the order receiving unit 314 registers the order-destination restaurant ID, the menu item ID of the ordered menu item, the number of pieces, and the like in the order history information.

Further, if it is indicated from the restaurant terminal 10 that the order is a “treat order”, the order receiving unit 314 of the processor 31 cooperates with the GUI providing unit 313 to cause the display device 16 of the order-source restaurant terminal 10 to display a prepaid screen 127 for payment for the menu item.

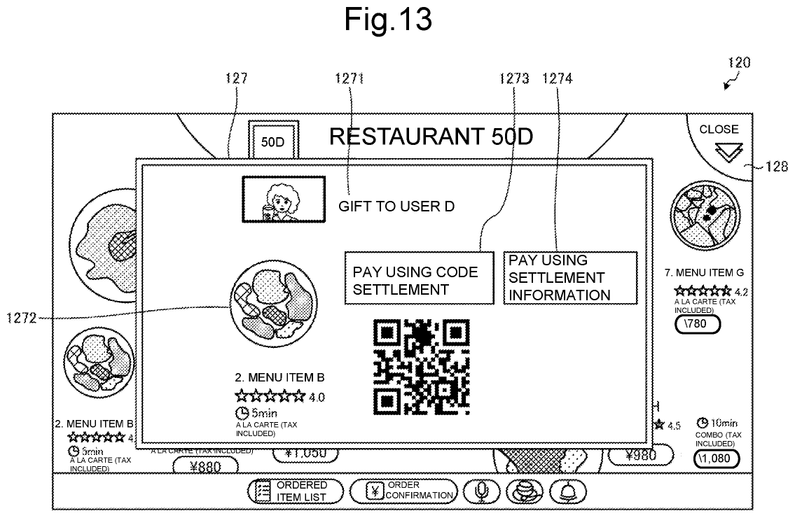

FIG. 13 is a diagram showing another example of a screen displayed on the restaurant terminal 10. FIG. 13 shows an example in which the prepaid screen 127 is superimposed and displayed on the menu screen 120. As shown in FIG. 13, a message 1271 for confirming the user name (user D) of the order-destination user and confirming that the menu item is given to that user as a gift is displayed on the prepaid screen 127. Note that FIG. 13 shows an example in which the image data acquired by the restaurant terminal 10 operated by the order-destination user is displayed together with the message 1271.

Further, the menu item name, price, menu item image, and the like of the menu item ordered are displayed as order target information 1272 on the prepaid screen 127. Further, in the prepaid screen 127, a first payment method 1273 using code settlement and a second payment method 1274 using settlement information are displayed as information for guiding the payment method for the menu item.

The order-source user confirms the message 1271 and the order target information 1272, and if determining that there is no problem, pays the menu item by using one of the first payment method 1273 and the second payment method 1274. For example, in the case of paying by using the first payment method 1273, the user reads two-dimensional code information displayed under the first payment method 1273 by using the user terminal 20 of the user, thus paying for the menu item indicated in the order target information 1272.

For example, the GUI providing unit 313 of the processor 31 displays, on the prepaid screen 127, two-dimensional code information that holds the order-source user ID, a notification destination (an address of the server device 30) when the payment is completed, and the like, in addition to the price of the menu item and the restaurant 50 to which the payment is made. After performing code settlement on the basis of the two-dimensional code information, the user terminal 20 notifies the server device 30 of various types of information included in the two-dimensional code information. As a result, the server device 30 can recognize that the payment for the menu item has been made by the code settlement. Note that a known technique is used for the code settlement.

Further, in the case of paying using the second payment method 1274, the user can pay for the menu item by operating the second payment method 1274 displayed as an operating element. Upon receiving the operation of the second payment method 1274, the checkout processing unit 315 of the processor 31 of the server device 30 performs checkout processing for paying for the menu item indicated in the order target information 1272 by using the settlement information of the order-source user registered in the user management table 353 (see FIG. 6).

When the checkout processing is completed, the checkout processing unit 315 of the processor 31 cooperates with the order receiving unit 314 to change the payment completion flag included in the order history information to “1”. The order receiving unit 314 then notifies the restaurant server of the restaurant 50, which corresponds to the order-destination restaurant ID, of the order information including the menu item ID of the ordered menu item, the user ID of the order-destination user, the terminal ID of the restaurant terminal 10 operated by that user, and the like.

The order receiving unit 314 of the processor 31 registers the order history information, in which the order-source user ID and the order-destination user ID different from each other are set in association with a newly issued order ID, in the order management table 355 (see FIG. 8). Further, the order receiving unit 314 registers the order-destination restaurant ID, the menu item ID of the ordered menu item, the number of pieces, and the like in the order history information of the order management table 355.

The restaurant server that has received the notification of the order information from the server device 30 notifies a waitperson or the like of the notified menu item to prompt the waitperson or the like to cook the ordered menu item. When the waitperson or the like carries the cooked menu item to the user of the order-destination user ID, the delivery of the ordered menu item is completed.

Note that, when the order-source and order-destination users (user IDs) are different from each other, the order receiving unit 314 of the processor 31 may control the notification of the order information with the consent of the order-destination user.

Returning to the description of FIG. 12, the menu screen 120 includes a close button 128 for returning to the main screen 110. When receiving the operation of the close button 128 via the restaurant terminal 10, the GUI providing unit 313 of the processor 31 causes the display device 16 of the restaurant terminal 10 to hide the menu screen 120 and display the main screen 110 again. Note that the return to the main screen 110 is not limited to the operation of the close button 128. For example, the GUI providing unit 313 may return the display to the main screen 110 when the operation of double-tapping the reduced screen 126 is received.

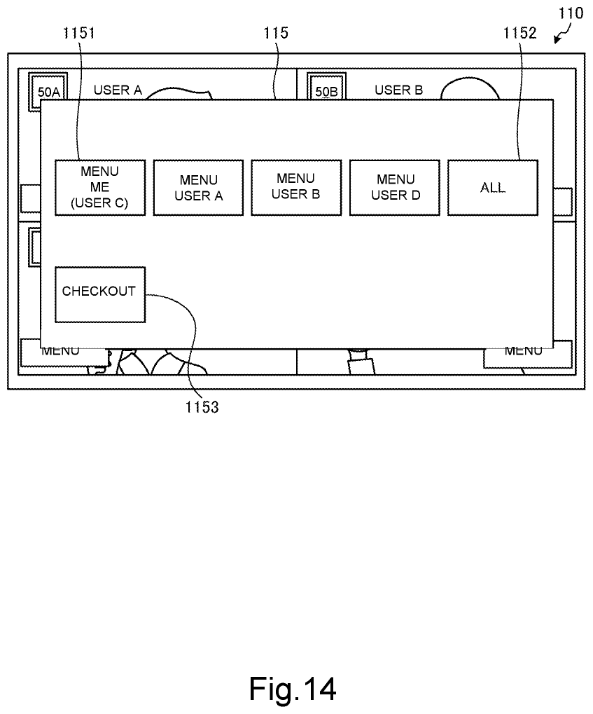

Further, as shown in FIG. 11, an overall menu button 114 is provided at the center of the main screen 110. When receiving the operation of the overall menu button 114 from the restaurant terminal 10, the GUI providing unit 313 of the processor 31 causes the display device 16 of the restaurant terminal 10 to display an overall menu screen 115 shown in FIG. 14.

FIG. 14 is a diagram showing another example of a screen displayed on the restaurant terminal 10. FIG. 14 shows an example in which the overall menu screen 115 is superimposed and displayed on the main screen 110. As shown in FIG. 14, a first operation button 1151 provided for each user and a second operation button 1152 are displayed on the overall menu screen 115.

Here, the first operation button 1151 is provided for each of the users belonging to the same group or for each of the restaurants 50 used by the respective users. Further, the first operation button 1151 is an operating element for instructing the display of the menu of the corresponding restaurant 50.

For example, the first operation button 1151 described as “user A” is an operating element for displaying a menu of the restaurant 50 used by the user A. Further, the first operation button 1151 described as “me” is an operating element for displaying a menu of the restaurant 50 used by the user (user C) who operates the restaurant terminal 10.

When receiving the operation of the first operation button 1151 from the restaurant terminal 10, the GUI providing unit 313 of the processor 31 causes the display device 16 of the restaurant terminal 10 to display the menu screen 120 described above (see FIG. 12) on the basis of the menu information of the restaurant 50 corresponding to the first operation button 1151 operated.

On the other hand, the second operation button 1152 is an operating element for instructing the display of a common menu in all the restaurants 50 used by the respective users of the same group.

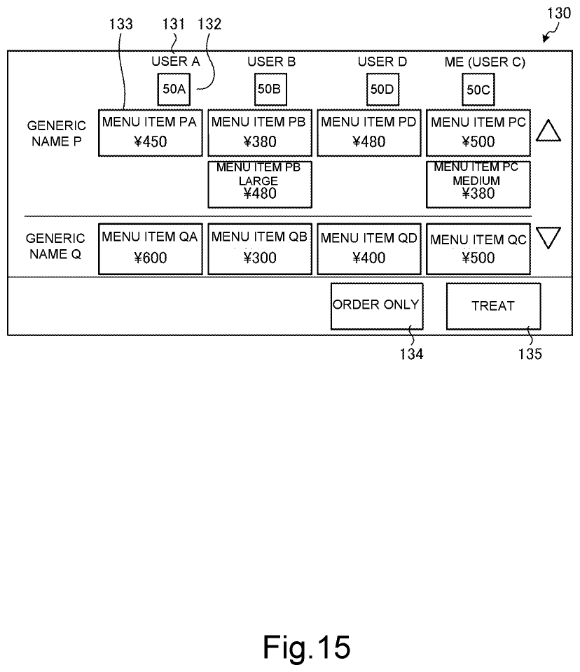

Upon receiving the operation of the second operation button 1152 from the restaurant terminal 10, the GUI providing unit 313 of the processor 31 extracts the menu item information (menu item name, price, etc.) of a menu item having a common generic name from the menu information of the restaurants 50 used by the respective users belonging to the same group. Next, the GUI providing unit 313 causes the display device 16 of the restaurant terminal 10 to display a common menu item screen 130 (see FIG. 15) based on the extracted menu item information.

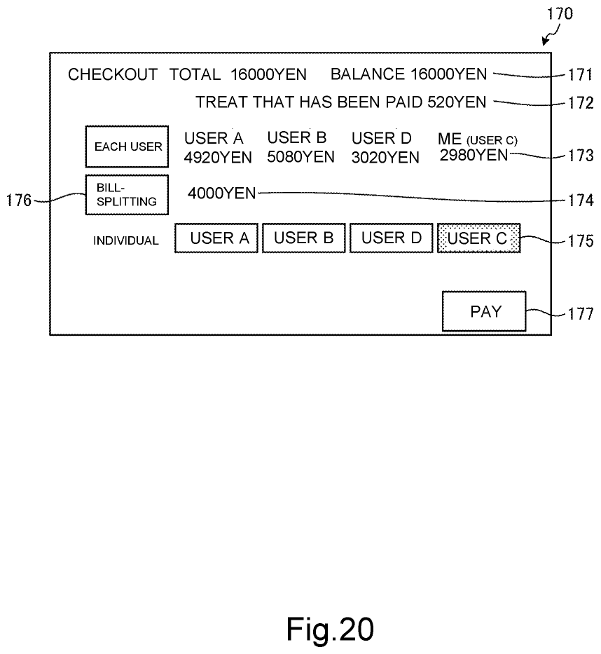

Note that, when displaying a menu screen including the menu screen 120, the overall menu screen 115, the common menu item screen 130 to be described later, a checkout screen 170 shown in FIG. 20, or the like (hereinafter, each referred to as an operation screen) on the main screen 110, the GUI providing unit 313 may adjust the sizes of the main screen 110 and the operation screen so as to display both the main screen 110 and the operation screen. Alternatively, when the operation screen is superimposed and displayed on the main screen 110, the GUI providing unit 313 may make the facial expression of the user of the main screen 110 visible by adjusting the size of the operation screen to a small size, or making the background other than the operation buttons (operating elements) of the operation screen “watermark”, for example. As a result, the user who operates the restaurant terminal 10 can continue a conversation with other users without an uncomfortable feeling while browsing and operating the operation screen including the menu screen 120, the overall menu screen 115, the checkout screen 170, or the like.

FIG. 15 is a diagram showing another example of a screen displayed on the restaurant terminal 10. FIG. 15 shows a display example of the common menu item screen 130. As shown in FIG. 15, user ID information 131 indicating the user ID of each user belonging to the same group and a restaurant image 132 of the restaurant 50 used by that user are displayed in association with each other on the common menu item screen 130. Here, the user ID information 131 denoted as “me” means the user (user C) who operates the restaurant terminal 10.

Further, on the common menu item screen 130, operation buttons 133 indicating menu items regarding the generic names P and Q common to the restaurants 50 are displayed so as to be arranged in the vertical direction for each restaurant 50 that provides those menu items. Further, the operation buttons 133 are displayed side by side for each generic name. In each of the operation buttons 133, a menu item name, a price, and the like of the corresponding menu item are displayed.

Thus, the user of the restaurant terminal 10 can easily confirm the common menu in each restaurant 50 used by the user in the remote drinking party by viewing the common menu item screen 130. Thus, for example, when all users who participate in the remote drinking party order a common menu item such as beer or the like, the user of the restaurant terminal 10 can easily select the menu item common to the respective restaurants 50 by viewing the common menu item screen 130.

Here, the operation button 133 functions as an operating element for selecting a menu item to be ordered. Specifically, the operation button 133 is associated with the menu item ID of the corresponding menu item. After selecting one or a plurality of operation buttons 133, the user can order the selected menu items by operating an order-only button 134 or a treat button 135 provided at the lower portion of the screen.

Further, the operation button 133 is associated with a user ID of the corresponding user ID information 131 and a restaurant ID of the restaurant 50 corresponding to the restaurant image 132. For example, when the operation button 133 on which a “menu item PA” is described is operated, the user ID of the user A corresponding to the operation button 133 and the restaurant ID of the restaurant 50A are selected as the order destination together with the menu item ID of the “menu item PA”.

The order-only button 134 is an operating element for instructing the order method in which the order-destination user pays for the ordered menu item. When receiving the operation of the order-only button 134 via the restaurant terminal 10, the order receiving unit 314 of the processor 31 determines whether or not the user ID of the order-source user who has performed that operation matches the user ID of the order-destination user selected by the operation button 133.

Here, when both the user IDs match with each other, the order receiving unit 314 of the processor 31 determines that the user has ordered the menu item to eat and drink for himself/herself, and in the same manner as described above, performs the notification of the order information to the restaurant server of the order-destination restaurant 50 and the registration of the order history information in the order management table 355 (see FIG. 8).

On the other hand, when both the user IDs are different from each other, the order receiving unit 314 of the processor 31 determines that the order-source user has ordered the menu item for another user to eat and drink. In this case, the order receiving unit 314 causes the display device 16 of the restaurant terminal 10 operated by the order-destination user to display a confirmation screen 140 for confirming whether to accept the order.

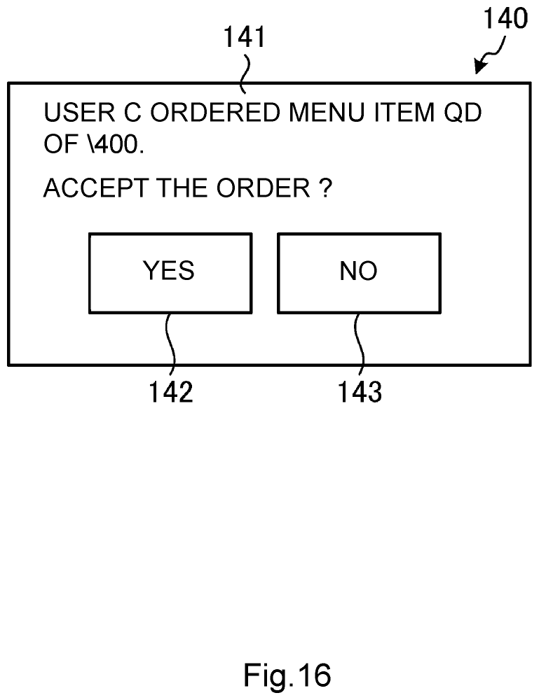

FIG. 16 is a diagram showing another example of a screen displayed on the restaurant terminal 10. FIG. 16 shows a screen example of the confirmation screen 140. As shown in FIG. 16, a message 141 for confirming whether to accept the order is displayed on the confirmation screen 140. Note that FIG. 16 shows an example in which the menu item name and price of the ordered menu item and the user name of the order-source user are displayed together as the message 141.

Further, the confirmation screen 140 displays an operation button 142 for instruction to accept the order and an operation button 143 for instruction to reject the order. After confirming the message 141, the order-destination user gives a response about whether to accept the order by operating either the operation button 142 or the operation button 143.

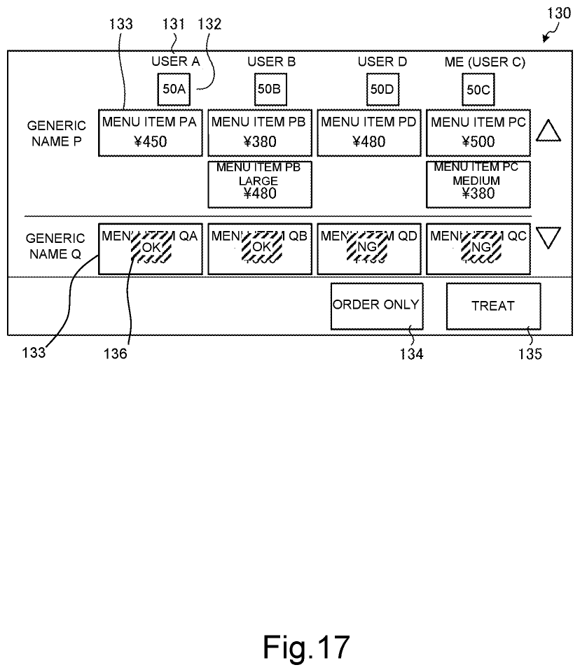

Here, when receiving the operation of the operation button 143 from the restaurant terminal 10, the order receiving unit 314 of the processor 31 displays result information 136, which indicates that the order-destination user rejects the order, on the common menu item screen 130 displayed on the order-source restaurant terminal 10 (see FIG. 17).

Further, when receiving the operation of the operation button 142 from the order-destination restaurant terminal 10, the order receiving unit 314 of the processor 31 notifies the restaurant server of the restaurant 50, which corresponds to the order-destination restaurant ID, of the order information. Further, the order receiving unit 314 registers the order history information regarding the ordered menu item in the order management table 355 (see FIG. 8). The order receiving unit 314 then displays the result information 136, which indicates that the order-destination user accepts the order, on the common menu item screen 130 displayed on the order-source restaurant terminal 10 (see FIG. 17).

FIG. 17 is a diagram showing another example of a screen displayed on the restaurant terminal 10. FIG. 17 shows an example of the common menu item screen 130 on which the result information 136 is displayed. Here, the following state is shown: after each menu item of the generic name Q is selected by the operation button 133, the order-only button 134 is operated.

As described above, the order receiving unit 314 of the processor 31 confirms whether or not the order is accepted for each order-destination user, and displays the confirmation result as the result information 136 on the common menu item screen 130 (FIG. 17). For example, the order receiving unit 314 cooperates with the GUI providing unit 313 to superimpose and display the result information 136 on the selected operation button 133 as shown in FIG. 17.

Here, for example, an “OK” mark, which is the result information 136 indicating that the order is accepted, is displayed for the user A. Further, for example, an “NG” mark, which is the result information 136 indicating that the order is rejected, is displayed for the user D. Note that FIG. 17 shows an example in which the result information 136 is also displayed on “me” (user C), which is the order-source user.

As described above, when a certain user orders a menu item for another user to eat and drink, the server device 30 confirms whether or not the order is accepted to the order-destination user (the other user), and when the instruction to accept the order is performed, orders the menu item. In addition, the server device 30 provides the order-source user with the result information 136 indicating the confirmation result on whether the order is accepted or not by the order-destination user. As a result, the order-source user can easily confirm the acceptance status of the order-destination user, so that convenience can be improved.

Further, in the common menu item screen 130 shown in FIG. 17, the treat button 135 is an operating element for instructing an order method (treat order) in which the order-source user pays for a menu item ordered for an order-destination user who is different from the order-source user. When receiving the operation of the treat button 135 from the restaurant terminal 10, the order receiving unit 314 of the processor 31 determines whether or not the user ID of the order-source user who has performed the operation matches the user ID of the order-destination user selected by the operation button 133.

Here, when both the user IDs match with each other, the order receiving unit 314 of the processor 31 invalidates the operation of the treat button 135. On the other hand, when both the user IDs are different from each other, the order receiving unit 314 cooperates with the GUI providing unit 313 to cause the display device 16 of the restaurant terminal 10 operated by the order-source user to display a confirmation screen 150 for confirming whether or not the treat order is to be performed.

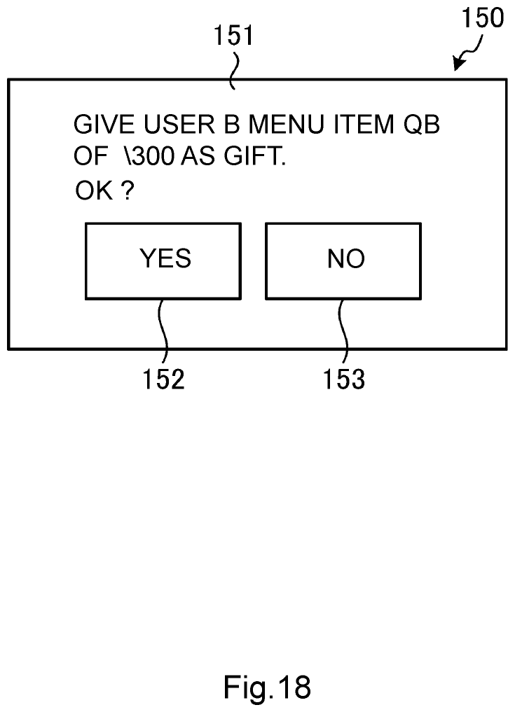

FIG. 18 is a diagram showing another example of a screen displayed on the restaurant terminal 10. FIG. 18 shows a display example of the confirmation screen 150. As shown in FIG. 18, a user name (user B) of the order-destination user ID and a message 151 for confirming whether or not a gift is to be given to that user are displayed on the confirmation screen 150. Note that, when a plurality of order-destination users are selected, that is, when a plurality of menu items are selected, the selected contents are displayed in the message 151.

Further, an operation button 152 for instruction to perform the order and an operation button 153 for instruction to cancel the order are displayed on the confirmation screen 150. After confirming the message 151, the order-source user gives a response about whether to perform the order by operating either the operation button 152 or the operation button 153.

When receiving the operation of the operation button 153 from the order-source restaurant terminal 10, the order receiving unit 314 of the processor 31 hides the confirmation screen 150 and returns the screen to the common menu item screen 130 shown in FIG. 15. On the other hand, when receiving the operation of the operation button 152 from the order-source restaurant terminal 10, the order receiving unit 314 cooperates with the GUI providing unit 313 to cause the display device 16 of the restaurant terminal 10 to display a prepaid screen 160 for payment for the menu item.

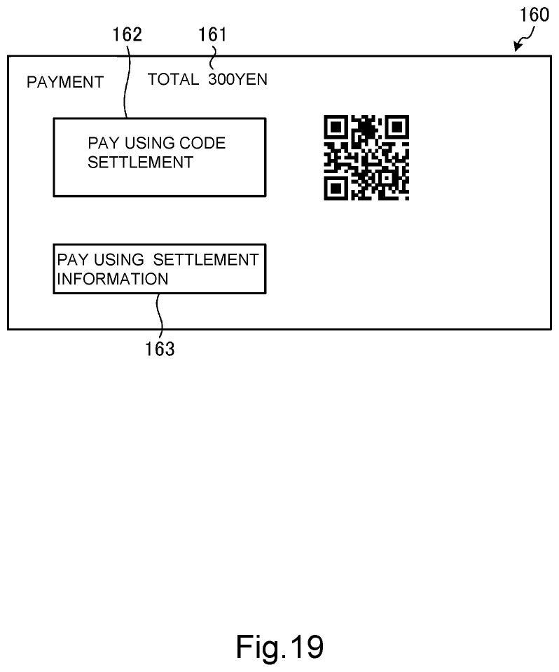

FIG. 19 is a diagram showing another example of a screen displayed on the restaurant terminal 10. FIG. 19 shows a display example of the prepaid screen 160. As shown in FIG. 19, the prepaid screen 160 displays the total amount 161 of menu items to be paid by the order-source user. The total amount 161 is calculated by adding the unit prices of the menu items selected by the operation button 133.

Further, in the prepaid screen 160, a first payment method 162 using code settlement and a second payment method 163 using settlement information are displayed as information for guiding the payment method for the menu item. The first payment method 162 and the second payment method 163 are the same as the first payment method 1273 and the second payment method 1274 described above, and the payment for the menu item can be performed using either one of the methods.

When the payment for the menu item is completed by any one of the first payment method 162 and the second payment method 163, the order receiving unit 314 of the processor 31 notifies the restaurant server of the order-destination restaurant 50 of the order information in the same manner as described above. Further, the order receiving unit 314 registers the order history information, in which the payment completion flag is set to “1”, in the order management table 355 (see FIG. 8).

Note that the following configuration may be provided, in which even when the order-source user performs an order using the treat button 135 (treat order) shown in FIG. 17, the order-source user may confirm whether or not the order-destination user accepts the order. In this case, it is favorable that the order receiving unit 314 of the processor 31 causes the restaurant terminal 10 of the order-source user to display the confirmation screen 150 of FIG. 18, and after obtaining an instruction to perform the order, confirms whether or not the order-destination user accepts the order. Further, after the confirmation about whether or not the order-destination user accepts the order is obtained, it is favorable that the order receiving unit 314 causes the restaurant terminal 10 of the order-source user to display the prepaid screen 160 including the total amount 161 reflecting the confirmation result.

Returning to the description of FIG. 14, a checkout button 1153 to instruct the checkout is provided on the overall menu screen 115. Upon receiving the operation of the checkout button 1153 from the restaurant terminal 10, the checkout processing unit 315 of the processor 31 performs the checkout processing of the ordered menu items on the basis of the order history information of the corresponding reservation ID registered in the order management table 355 (see FIG. 8). Note that the reservation ID can be specified from the terminal ID or the like of the restaurant terminal 10 on which the operation of the checkout button 1153 has been performed.

Specifically, the checkout processing unit 315 of the processor 31 calculates the total amount of the menu items as the total payment amount on the basis of the remaining order history information excluding the order history information in which the payment completion flag is “1” in the order history information associated with the corresponding reservation ID. Further, the checkout processing unit 315 calculates the total amount for each user (user ID) on the basis of the user ID of the order-destination user, which is recorded in the remaining order history information. In addition, the checkout processing unit 315 calculates a split bill amount obtained by dividing the total payment amount by the number of users belonging to the same group. In addition, the checkout processing unit 315 derives the total amount of the menu items, which is calculated on the basis of the order history information in which the payment completion flag is “1”, as the amount that has been paid.

The checkout processing unit 315 of the processor 31 then cooperates with the GUI providing unit 313 to cause the display device 16 of the restaurant terminal 10 operated by each user who participates in the remote drinking party to display the checkout screen 170.

FIG. 20 is a diagram showing another example of a screen displayed on the restaurant terminal 10. FIG. 20 shows a display example of the checkout screen 170. As shown in FIG. 20, first information 171 indicating the total payment amount of the menu items and the balance is displayed on the checkout screen 170. Further, second information 172 indicating the amount that has been paid is displayed on the checkout screen 170. At the stage when the checkout screen 170 is displayed, the payment operation is not performed, and thus the total payment amount and the balance displayed in the first information 171 are equal to each other.

In addition, the total amount 173 calculated for each user is displayed on the checkout screen 170. The total amount 173 is displayed in association with the user name, for example. Here, the user name “me” means the user (user C) who operates the restaurant terminal 10. Further, a split bill amount 174 is displayed on the checkout screen 170.

Thus, each user who operates the restaurant terminal 10 can easily confirm the total payment amount of the menu items ordered in the remote drinking party and the total amount of the menu items that each person has eaten and drunk, by viewing the checkout screen 170 of FIG. 20 displayed on the display device 16 of the restaurant terminal 10.

Further, on the checkout screen 170 of FIG. 20, individual buttons 175 and a bill-splitting button 176 are provided as operating elements for designating a payment method. The individual button 175 is provided for each user and is used when the user pays any amount (hereinafter, also referred to as “individual payment”).

Specifically, upon receiving the operation of the individual button 175 from the restaurant terminal 10, the checkout processing unit 315 of the processor 31 cooperates with the GUI providing unit 313 to cause the display device 16 of the restaurant terminal 10 to display an amount input screen 180.

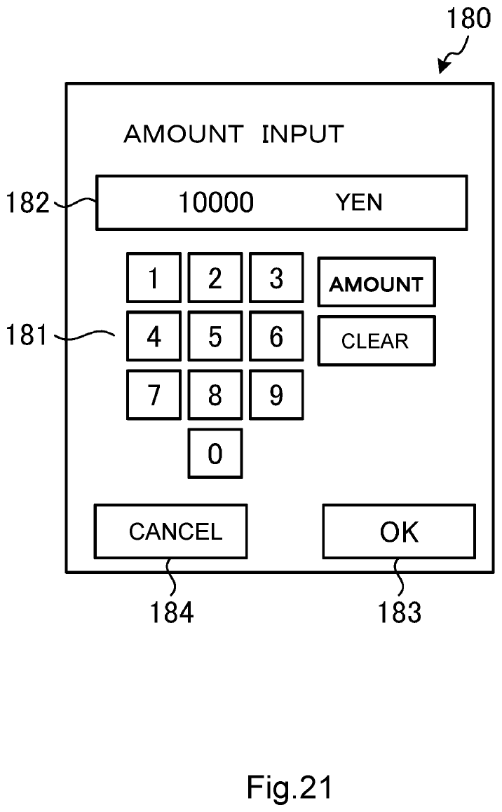

FIG. 21 is a diagram showing another example of a screen displayed on the restaurant terminal 10. FIG. 21 shows a display example of the amount input screen 180. As shown in FIG. 21, the amount input screen 180 is provided with operation buttons 181 such as numerical keys and a display area 182. When the user of the restaurant terminal 10 inputs a desired amount via the operation buttons 181, the input amount is displayed in the display area 182. Note that a clear button included in the operation buttons 181 is an operating element for clearing the input amount. Further, an amount button included in the operation buttons 181 is an operating element for inputting the balance displayed on the checkout screen 170.

Further, the amount input screen 180 is provided with an OK button 183 and a cancel button 184. Upon receiving the operation of the cancel button 184 from the restaurant terminal 10, the checkout processing unit 315 of the processor 31 hides the amount input screen 180 and displays the checkout screen 170 of FIG. 20 again.

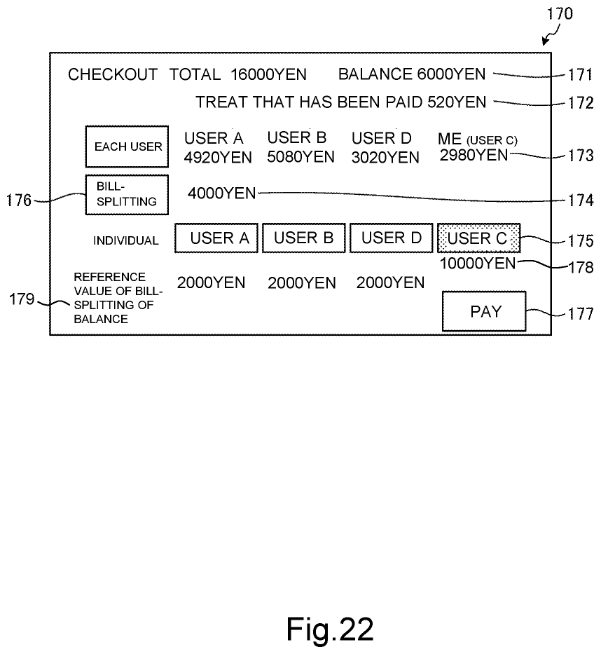

Further, upon receiving the operation of the OK button 183 from the restaurant terminal 10, the checkout processing unit 315 of the processor 31 sets the amount input to the display area 182 as the amount to be paid by the user of the restaurant terminal 10 (payment amount). As shown in FIG. 22, the checkout processing unit 315 causes the display device 16 of the restaurant terminal 10 operated by each user of the same group to display the checkout screen 170 in which the first information 171 and the like are updated.

FIG. 22 is a diagram showing another example of a screen displayed on the restaurant terminal 10. FIG. 22 shows a state after the checkout screen 170 described with reference to FIG. 20 is updated. As shown in FIG. 22, on the updated checkout screen 170, input amount information 178 indicating the payment amount input to the amount input screen 180 is displayed in association with the user name (individual button 175) of the user who has performed the input operation. Further, the balance of the first information 171 is updated to a value obtained by subtracting the payment amount indicated by the input amount information 178 from the total payment amount.

Further, a split bill amount obtained by dividing the updated balance 171 by the number of users who have not yet input the amount to the amount input screen 180 is displayed as a reference value 179. In FIG. 22, the amount has not been input by three persons of the user A, the user B, and the user D, and thus “2000 yen” obtained by dividing the balance “6000 yen” by the three persons is displayed as the reference value 179.

On the other hand, the bill-splitting button 176 is used when each user pays the split bill amount (hereinafter, also referred to as “bill-splitting payment”). Upon receiving the operation of the bill-splitting button 176, the checkout processing unit 315 of the processor 31 sets the split bill amount, which is displayed on the checkout screen 170 of FIG. 22, for the payout amount of each user.

For example, in the state of the checkout screen 170 shown in FIG. 20, when receiving the operation of the bill-splitting button 176, the checkout processing unit 315 of the processor 31 sets the payment amount of each of the users A, B, C, and D to 4000 yen. Further, for example, in the state of the checkout screen 170 shown in FIG. 22, when receiving the operation of the bill-splitting button 176, the checkout processing unit 315 sets the payment amount of each of the users A, B, and D who have not yet input the amount to 2000 yen shown in the reference value 179.

When the balance reaches “0”, the checkout processing unit 315 of the processor 31 validates a payment button 177, which is arranged at the lower right of the screen, in an operable state. Here, the payment button 177 is an operating element for instructing execution of checkout processing.

Upon receiving the operation of the payment button 177 from any of the restaurant terminals 10 operated by the users A to D, the checkout processing unit 315 of the processor 31 performs checkout processing in which the payment amounts set for the respective users are paid using the settlement information of the users. Specifically, the checkout processing unit 315 performs checkout processing of paying for the amount corresponding to the prices of the menu items ordered in the restaurants 50 on each of the restaurants 50 used by the respective users.

When the checkout processing is completed, the reservation receiving unit 311 of the processor 31 determines that the remote drinking party of the corresponding reservation ID is ended, and invalidates the data entry of the reservation ID. For example, the reservation receiving unit 311 deletes the data entry of the reservation ID whose remote drinking party is ended, or moves to another data table.

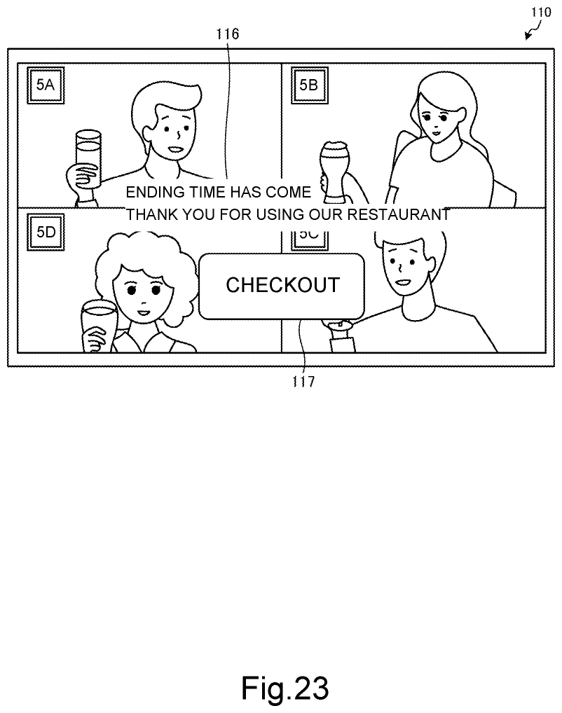

Note that, when the ending date and time of the reservation date and time has come, the reservation receiving unit 311 (or the checkout processing unit 315 etc.) of the processor 31 may cooperate with the GUI providing unit 313 to cause the display device 16 of the restaurant terminal 10 operated by each user to display an end notification screen (see FIG. 23) for indicating that the ending date and time has come.

FIG. 23 is a diagram showing another example of a screen displayed on the restaurant terminal 10. FIG. 23 shows an example in which a message 116 for indicating that the ending date and time has come is superimposed and displayed on the main screen 110 as an example of the end notification screen. In this case, the transition to the checkout processing can be smoothly promoted by displaying the same checkout button 117 as the checkout button 1153 described above on the end notification screen (main screen 110).

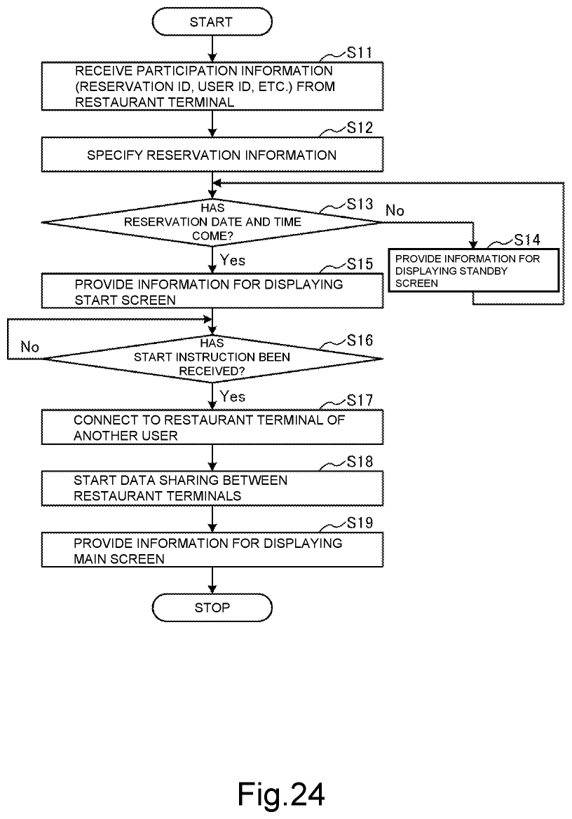

Hereinafter, an operation example of the server device described above will be described with reference to flowcharts of FIGS. 24 to 27.

FIG. 24 is a flowchart showing an example of the login processing performed by the processor 31 of the server device 30. As a precondition for this processing, a reservation for a remote drinking party has been made.

First, in Step S11, the inter-terminal communication unit 312 of the processor 31 receives, from a restaurant terminal 10 of a restaurant 50, participation information including a user ID of a user who operates the restaurant terminal 10, a reservation ID of a remote drinking party, and the like. Next, in Step S12, the inter-terminal communication unit 312 of the processor 31 refers to the reservation management table 354 shown in FIG. 7 and specifies reservation information corresponding to the condition of the participation information.

Subsequently, in Step S13, the inter-terminal communication unit 312 of the processor 31 compares the reservation date and time (starting date and time) included in the reservation information with the current date and time, and determines whether or not the reservation date and time has come. Here, if the current date and time has not reached the reservation date and time (Step S13: No), the processing of the processor 31 proceeds to Step S14. In Step S14, the inter-terminal communication unit 312 of the processor 31 cooperates with the GUI providing unit 313 to provide the restaurant terminal 10 with information for displaying a standby screen on the restaurant terminal 10. The processing of the processor 31 then returns to Step S13.

Further, if the current date and time has reached the reservation date and time (Step S13: Yes), the processing of the processor 31 proceeds to Step S15. In Step S15, the inter-terminal communication unit 312 of the processor 31 cooperates with the GUI providing unit 313 to provide the restaurant terminal 10 with information for displaying the start screen 100 (see FIG. 10) of the remote drinking party on the restaurant terminal 10.

Subsequently, in Step S16, the inter-terminal communication unit 312 of the processor 31 determines whether or not a start instruction has been received from the restaurant terminal 10. The inter-terminal communication unit 312 then waits until a start instruction is received from the restaurant terminal 10 (Step S16: No). If a start instruction is received from the restaurant terminal 10 (Step S16: Yes), the processing of the processor 31 proceeds to Step S17. In Step S17, the inter-terminal communication unit 312 of the processor 31 establishes communication between the restaurant terminal 10 that has transmitted the participation information and a restaurant terminal 10 of another user registered in the reservation information. In Step S18, the inter-terminal communication unit 312 starts data sharing between the restaurant terminals 10.

Next, in Step S19, the GUI providing unit 313 of the processor 31 provides the restaurant terminal 10 that has transmitted the participation information with information for displaying the main screen 110 (see FIG. 11) on the restaurant terminal 10. The processor 31 then terminates the processing shown in FIG. 24.

By performing the processing of FIG. 24, the server device 30 can provide the restaurant terminal 10 with an environment where a remote drinking party can be performed.

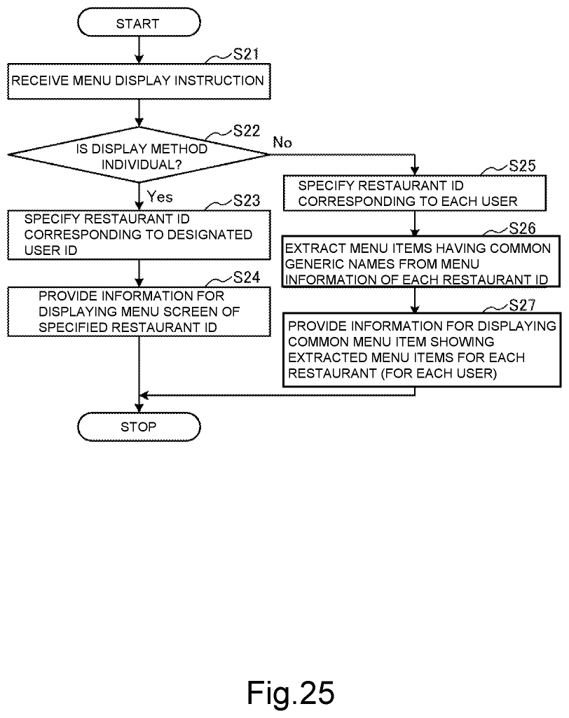

FIG. 25 is a flowchart showing an example of the menu providing processing performed by the server device 30. Note that FIG. 25 shows an example of the processing of the processor 31 of the server device 30, which is performed when the menu button 113 or the overall menu button 114 is operated from the main screen 110 (see FIG. 11) displayed on the display device 16 of the restaurant terminal 10.

First, in Step S21, the GUI providing unit 313 of the processor 31 receives a menu display instruction from the restaurant terminal 10 through the menu button 113 or overall menu button 114 described above. In Step S22, the GUI providing unit 313 determines whether the received display instruction is given by the operation of the menu button 113 or the overall menu button 114. Specifically, the GUI providing unit 313 determines whether the display method is an individual display method of displaying the menu for each restaurant 50 or an overall display method of displaying the menu common to all the restaurants 50.

Here, if it is determined that the display instruction by the menu button 113, that is, the individual display method for each restaurant 50 is instructed (Step S22: Yes), the processing of the processor 31 proceeds to Step S23. In Step S23, the GUI providing unit 313 of the processor 31 specifies the restaurant ID of the restaurant 50 designated as a menu displaying target. For example, the GUI providing unit 313 specifies the restaurant ID of the restaurant 50 designated as a menu displaying target from the information of the restaurant 50 allocated to the operated menu button 113, or the like.

Subsequently, in Step S24, the GUI providing unit 313 of the processor 31 reads the menu information of the restaurant ID specified in Step S23 from the menu management table 352. The GUI providing unit 313 provides the restaurant terminal 10 with information for displaying the menu screen 120 (see FIG. 12) based on the read menu information on the restaurant terminal 10. The processor 31 then terminates the processing shown in FIG. 25.

Further, if it is determined in Step S22 that the display instruction by the overall menu button 114, that is, the overall display method for the restaurants 50 is instructed (Step S22: No), the processing of the processor 31 proceeds to Step S25. In Step S25, the GUI providing unit 313 of the processor 31 specifies the restaurant ID of the restaurant 50 used by each user on the basis of the reservation information and the like. Next, in Step S26, the GUI providing unit 313 extracts menu item information of menu items having common generic names from the menu information corresponding to each restaurant ID specified in Step S25.

Next, in Step S27, the GUI providing unit 313 of the processor 31 provides the restaurant terminal 10 with information for causing the restaurant terminal 10 to display the common menu item screen 130 (see FIG. 15) showing the menu item information extracted in Step S26 for each restaurant 50 (for each user). The processor 31 terminates the processing shown in FIG. 25.

The server device 30 can cause the display device 16 of the restaurant terminal 10 to display the menu screen 120 (see FIG. 12) or the common menu item screen 130 (see FIG. 15) by performing the processing of FIG. 25.

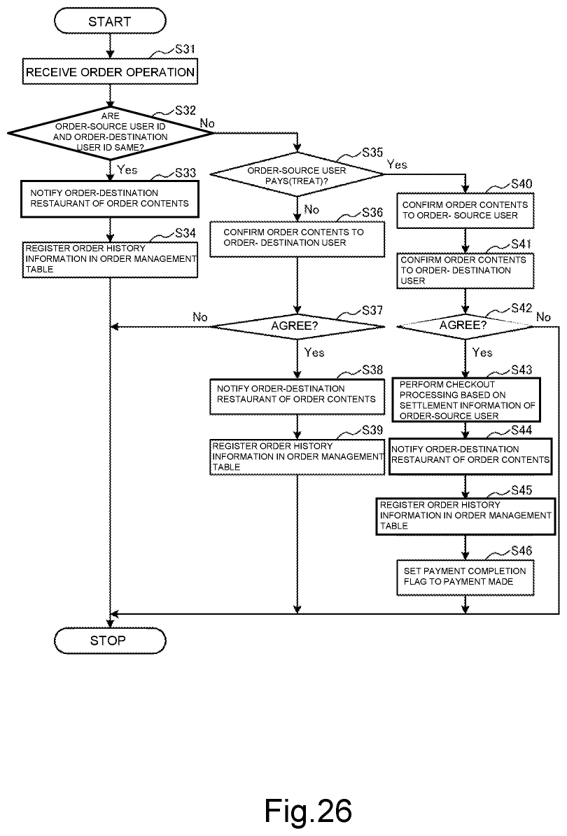

FIG. 26 is a flowchart showing an example of the order processing performed by the processor 31 of the server device 30. Note that FIG. 26 shows an example of the processing when an order operation based on the menu screen 120 or the common menu item screen 130 is received from the restaurant terminal 10.

First, in Step S31, the order receiving unit 314 of the processor 31 receives an order operation for a menu item from the restaurant terminal 10. Next, in Step S32, the order receiving unit 314 determines whether or not the order-source user ID matches the order-destination user ID. If both the user IDs match with each other (Step S32: Yes), that is, if the order receiving unit 314 determines that the user has ordered the menu item to eat and drink for himself/herself, the processing of the processor 31 proceeds to Step S33. In Step S33, the order receiving unit 314 of the processor 31 notifies the order-destination restaurant 50 of the order contents (menu item ID, order-source user ID, and the like). Next, the order receiving unit 314 registers the order history information including the received order contents in association with the corresponding reservation ID of the order management table 355 (see FIG. 8). The processor 31 then terminates the processing shown in FIG. 26.

Further, if it is determined in Step S32 that both the user IDs are different from each other (Step S32: No), the processing of the processor 31 proceeds to Step S35. In Step S35, the order receiving unit 314 of the processor 31 determines whether or not a method (treat) in which the order-source user pays for the menu item is instructed.

Here, if a method in which the order-destination user pays for the menu item is instructed (Step S35: No), the processing of the processor 31 proceeds to Step S36. In Step S36, the order receiving unit 314 of the processor 31 displays the confirmation screen 140 (see FIG. 16) for confirming the order contents on the restaurant terminal 10 operated by the order-destination user. Next, the order receiving unit 314 waits until the confirmation result is received from the order-destination user.

In Step S37, the order receiving unit 314 of the processor 31 determines whether a response to reject the order contents or a response to agree with the order contents is received as the confirmation result. If a response to reject the order contents is received (Step S37: No), the order receiving unit 314 of the processor 31 terminates the processing shown in FIG. 26 without ordering the menu item. In this case, the order receiving unit 314 may provide the result information, which indicates the fact that a response to reject the order contents is received, to the restaurant terminal 10 operated by the order-source user.

Further, in Step S37, if a response to agree with the order contents is received (Step S37: Yes), the processing of the processor 31 proceeds to Step S38. In Step S38, the order receiving unit 314 of the processor 31 notifies the order-destination restaurant 50 of the order contents (menu item ID, order-destination user ID, and the like). Next, in Step S39, the order receiving unit 314 registers the order history information including the received order contents in association with the corresponding reservation ID of the order management table 355 (see FIG. 8). The processor 31 then terminates the processing shown in FIG. 26.

Meanwhile, in Step S35, if a method (treat) in which the order-source user pays for the menu item is instructed (Step S35: Yes), the processing of the processor 31 proceeds to Step S40. In Step S40, the order receiving unit 314 of the processor 31 displays the confirmation screen 150 (see FIG. 18) for confirming the order contents on the restaurant terminal 10 operated by the order-source user. Next, in Step S41, the order receiving unit 314 causes the restaurant terminal 10 operated by the order-destination user to display the confirmation screen 140 (see FIG. 16) for confirming the order contents. Next, the order receiving unit 314 waits until the confirmation result is received from each user.

In Step S42, the order receiving unit 314 determines whether a response to reject the order contents is received from either or both of the order-source user and the order-destination user, or whether a response to agree with the order contents is received from both of the order-source user and the order-destination user. Here, if a response to reject the order contents is received from either or both of the order-source user and the order-destination user (Step S42: No), the order receiving unit 314 of the processor 31 terminates the processing shown in FIG. 26 without ordering the menu item. If the order-destination user rejects the order contents, the order receiving unit 314 may provide the result information, which indicates the fact that the order-destination user rejects the order contents, to the restaurant terminal 10 operated by the order-source user.

Further, in Step S42, if a response to agree with the order contents is received from both of the order-source user and the order-destination user (Step S42: Yes), the processing of the processor 31 proceeds to Step S43. In Step S43, the checkout processing unit 315 of the processor 31 performs the checkout processing (payment) for the ordered menu item on the basis of the settlement information or the like of the order-source user.

Subsequently, in Step S44, the checkout processing unit 315 of the processor 31 notifies the order-destination restaurant 50 of the order contents (menu item ID, order-destination user ID, and the like). Next, in Step S45, the order receiving unit 314 of the processor 31 registers the order history information including the received order contents in association with the corresponding reservation ID of the order management table 355 (see FIG. 8). Next, in Step S46, the checkout processing unit 315 sets the payment completion flag of the order history information registered in Step S45 to “1” indicating that the payment has been made (Step S46). The processor 31 then terminates the processing shown in FIG. 26.

By performing the processing of FIG. 26, the server device 30 can order the menu item to the order-destination restaurant 50 while switching between a method in which the order-source user pays and a method in which the order-destination user pays according to the order operation from the restaurant terminal 10.

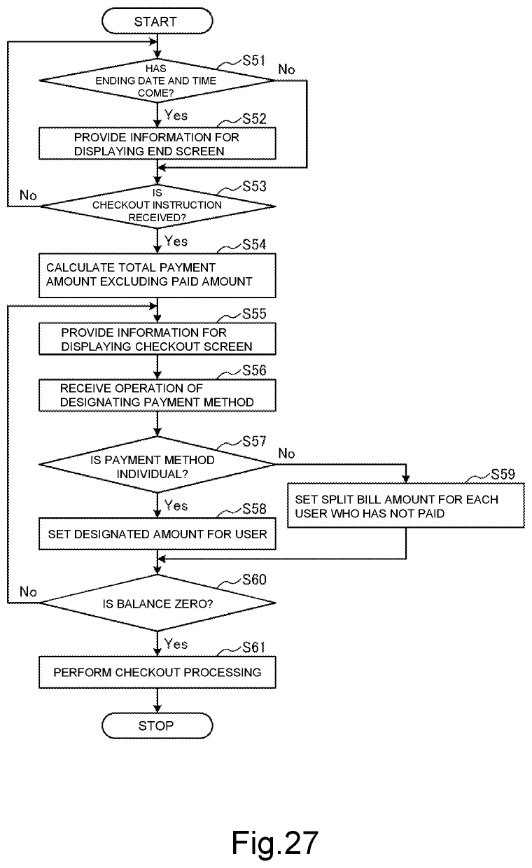

FIG. 27 is a flowchart showing an example of the checkout processing performed by the processor 31 of the server device 30. In FIG. 27, it is assumed that the order history information regarding the order received from the restaurant terminal 10 has been registered in the order management table 355 shown in FIG. 8.

First, in Step S51, the reservation receiving unit 311 of the processor 31 determines whether or not there is a reservation ID (remote drinking party) for which the current date and time has reached the ending date and time, on the basis of the reservation information registered in the reservation management table 354 (see FIG. 7). Here, if there is a reservation ID for which the current date and time has reached the ending date and time (Step S51: Yes), the processing of the processor 31 proceeds to Step S52. In Step S52, the reservation receiving unit 311 of the processor 31 provides the restaurant terminal 10 with information for causing each restaurant terminal 10 of the terminal ID associated with that reservation ID to display an end notification screen. The processing of the processor 31 proceeds to Step S53. Further, even if it is determined that there is no reservation ID for which the current date and time has reached the ending date and time (Step S51: No), the processing proceeds to Step S53.

In Step S53, the checkout processing unit 315 of the processor 31 determines whether or not a checkout instruction for the remote drinking party is received via the checkout button 1153 or the checkout button 117 described above. If the checkout instruction is not received (Step S53: No), the processing of the processor 31 returns to Step S51.

Further, in Step S53, if the checkout instruction is received (Step S53: Yes), the processing of the processor 31 proceeds to Step S54. In Step S54, the checkout processing unit 315 of the processor 31 calculates the total payment amount on the basis of the remaining order history information excluding the order history information in which the payment completion flag is “1” in the order history information regarding the reservation ID for which the checkout is to be performed. Next, in Step S55, the checkout processing unit 315 provides each of the restaurant terminals with information for causing each of the restaurant terminals 10 regarding the reservation ID for which the checkout is to be performed to display the checkout screen 170 (see FIG. 22) on the basis of the calculation result of Step S54 or the like.

Subsequently, in Step S56, the checkout processing unit 315 of the processor 31 receives an operation of designating a payment method from any of the restaurant terminals 10 to which the checkout screen 170 is provided. Next, in Step S57, the checkout processing unit 315 determines whether the designated payment method is “individual payment” or “bill-splitting payment”.

Here, if the designated payment method is the individual payment (Step S57: Yes), the processing of the processor 31 proceeds to Step S58. In Step S58, the checkout processing unit 315 of the processor 31 sets the designated amount for the payment amount of the user who has performed the payment operation. The processing of the processor 31 then proceeds to Step S60.

On the other hand, if the designated payment method is the bill-splitting payment (Step S57: No), the processing of the processor 31 proceeds to Step S59. In Step S59, the checkout processing unit 315 of the processor 31 sets the split bill amount for the payment amount of each user, the split bill amount being obtained by dividing the total payment amount or the balance obtained by subtracting the payment amount from the total payment amount, by the number of users who have not yet paid. Subsequently, the processing of the processor 31 proceeds to Step S60.

In Step S60, the checkout processing unit 315 of the processor 31 determines whether or not the balance obtained by subtracting the payment amount from the total payment amount is zero. Here, if it is determined that the balance is not zero (Step S60: No), the processing of the processor returns to Step S55. Thus, in Step S55, the checkout processing unit 315 of the processor 31 provides each of the restaurant terminals 10 with information for causing the restaurant terminal 10 to display the checkout screen in which the balance and the like have been updated.

Further, if it is determined in Step S60 that the balance is zero (Step S60: Yes), the processing of the processor 31 proceeds to Step S61. In Step S61, the checkout processing unit 315 of the processor 31 performs the checkout processing of paying the payment amount set for each user to each restaurant 50 using the settlement information of each user. The processor 31 then terminates the processing shown in FIG. 27.

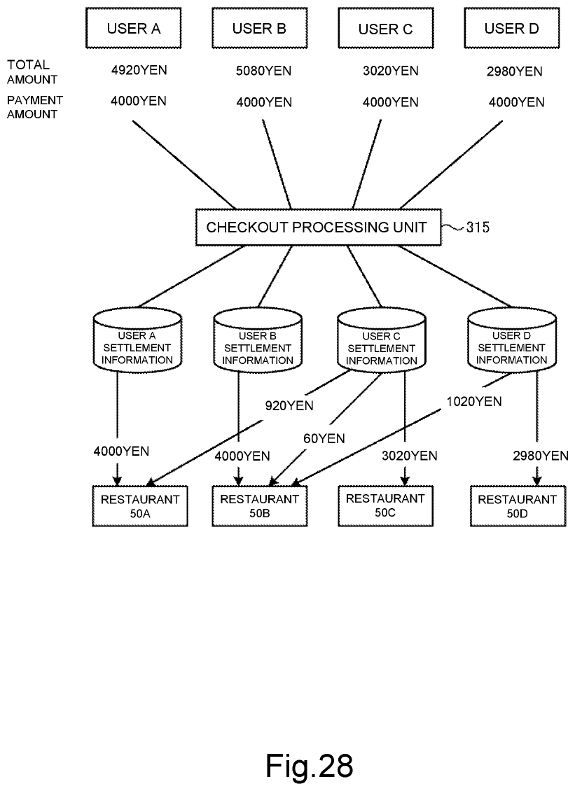

Here, FIG. 28 is a diagram for describing an operation example of the checkout processing performed by the checkout processing unit 315. FIG. 28 schematically shows the cases where the users A to D use the respective restaurants 50A to 50D.

In FIG. 28, it is assumed that the total amount of the menu items that the user A ate and drank in the restaurant 50A is 4920 yen, the total amount of the menu items that the user B ate and drank in the restaurant 50B is 5080 yen, the total amount of the menu items that the user C ate and drank in the restaurant 50C is 3020 yen, and the total amount of the menu items that the user D ate and drank in the restaurant 50D is 2980 yen. In addition, it is assumed that each user pays 4,000 yen uniformly by the bill-splitting payment.

In this case, the checkout processing unit 315 performs the checkout processing of paying the total amount of the food and beverages to the restaurants 50A to 50D by using the settlement information of each of the users A to D. First, the checkout processing unit 315 performs the checkout processing of paying the payment amount to each restaurant 50 used by each user by using the settlement information of that user. In this case, if the total amount in each restaurant 50 is less than the payment amount, the checkout processing unit 315 performs the checkout processing of paying the total amount.

For example, for the user A, the total amount (4920 yen) at the restaurant 50A is more than the payment amount (4000 yen). In this case, the checkout processing unit 315 performs processing for paying the payment amount to the restaurant 50A by using the settlement information of the user A. For user B, the total amount (5080 yen) at the restaurant 50B is more than the payment amount (4000 yen). In this case, the checkout processing unit 315 performs processing for paying the payment amount to the restaurant 50B by using the settlement information of the user B. Further, for example, for the user C, the total amount (3020 yen) at the restaurant 50C is less than the payment amount (4000 yen). In this case, the checkout processing unit 315 performs processing for paying the total amount to the restaurant 50C by using the settlement information of the user C. In addition, for example, for the user D, the total amount (2980 yen) at the restaurant 50D is less than the payment amount (4000 yen). In this case, the checkout processing unit 315 performs processing for paying the total amount to the restaurant 50D by using the settlement information of the user D.

In addition, in the payment described above, there may be a restaurant for which the payment does not reach the total amount. For example, in the restaurant 50A, a shortage of 920 yen occurs in the payment amount of the user A. Further, in the restaurant 50B, a shortage of 1080 yen occurs in the payment amount of the user B.

The checkout processing unit 315 performs processing for covering the amount of the shortage incurred in the restaurants 50A and 50B by using the settlement information of the users C and D who paid the total amounts in the previous checkout processing.

For example, the checkout processing unit 315 performs processing for paying 920 yen to the restaurant 50A and 60 yen to the restaurant 50B, respectively, on the basis of the difference of 980 yen between 3020 yen paid by the user C to the restaurant 50C and the payment amount of 4000 yen. Further, for example, the checkout processing unit 315 performs processing for paying 1020 yen to the restaurant 50B on the basis of the difference of 1020 yen between 2980 yen paid by the user D to the restaurant 50D and the payment amount of 4000 yen.

As a result, it is possible to cover the above-mentioned shortage that occurs in the restaurant 50A and the restaurant 50B. Therefore, the server device 30 can pay for the menu items ordered in the remote drinking party to each of the order-destination restaurants 50.

Note that the method for the checkout processing (payment method) performed by the checkout processing unit 315 is not limited to the example of FIG. 28. For example, the payment amount may be paid so as to satisfy the total amount sequentially from the restaurant 50A by using the settlement information of the users A to D. In this case, in the payment amount of 4000 yen of the user A, a shortage of 920 yen occurs in the restaurant 50A. So, the checkout processing unit 315 pays 920 yen to the restaurant 50A by using the settlement information of the next user B. Next, the following processing is performed: the balance of 3080 yen, which is obtained by subtracting 920 yen previously paid from the payment amount of 4000 yen of the user B, is paid to the restaurant 50B. If a shortage occurs, the checkout processing unit 315 covers the shortage by using the settlement information of the next user and can thus pay for the menu items ordered in the remote drinking party to each of the order-destination restaurants 50 in the same manner as described above.

As described above, when receiving access from each of the restaurant terminals 10 provided in the plurality of restaurants 50, the server device 30 manages the access-source restaurant 50 and the restaurant terminal 10 in association with the user who operates that restaurant terminal 10. Further, the server device 30 connects the restaurant terminals 10 of the users belonging to the same group so as to be communicable with each other. The server device 30 then provides menu information, which represents menu items that can be provided in the restaurant 50 to which the restaurant terminal 10 belongs, to each restaurant terminal 10 such that the restaurant terminals 10 connected to be communicable with each other can browse the menu information. Upon receiving an order of a menu item from any of the restaurant terminals 10 to which the menu information is provided, the server device 30 notifies the restaurant 50, which provides the menu item, of the information about the ordered menu item.

As a result, the server device 30 can support the order method of ordering the menu items that the user eats and drinks by himself/herself, and can support the order method of ordering the menu items that other users eat and drink, among the users belonging to the same group. Therefore, the server device 30 can improve the convenience related to a remote eating and drinking proving service using the plurality of restaurants 50.

Further, the server device 30 extracts menu information of menu items common to the restaurants 50 from the menu information of the restaurants 50 to which the restaurant terminals 10 communicably connected belongs, and provides the extracted menu information to each of the restaurant terminals 10 such that the restaurant terminals 10 belonging to the same group can browse the extracted menu information.

As a result, for example, when all users who participate in the remote drinking party order common menu items such as beer, the server device 30 can support the operation regarding such an order. Therefore, the server device 30 can improve the convenience related to the remote eating and drinking proving service using the plurality of restaurants 50.

Further, each time the order of a menu item is received, the server device 30 specifies an order-source user who has made the order and an order-destination user to which the ordered menu item is to be provided, and provides one or both of the order-source user and the order-destination user with a confirmation screen for confirming the order contents if both of the specified users are different from each other.

As a result, when the order of the menu item for another user to eat and drink is made, the server device 30 allows the order-source user to confirm whether or not the order has been accidentally ordered. Therefore, the server device 30 can suppress the occurrence of a mistaken order or the like. Further, the server device 30 can give the order-destination user the opportunity to determine whether to accept the order. Therefore, the server device 30 can prevent the order from being unthinkingly performed.

Further, the server device 30 performs the checkout processing of paying for the ordered menu items to the restaurant 50 that provides those menu items. In addition, the server device 30 performs the checkout processing for the ordered menu items on the basis of the split bill amount obtained by dividing the price of the ordered menu items by the number of users belonging to the same group, or the payment amount individually designated by the user.

As a result, the server device 30 can consistently performs the processing from order to checkout for the menu items in the remote drinking party using the plurality of restaurants 50. In addition, the server device 30 can pay for the menu items by using the payment method based on the split bill amount and the payment method based on the payment amount individually designated. Therefore, the server device 30 can improve the convenience related to the remote eating and drinking proving service using the plurality of restaurants.

Note that the embodiment described above can be implemented by appropriately modifying a part of the configuration or function of each device described above. Therefore, in the following, some modifications according to the embodiment described above will be described as other embodiments. Note that, in the following, points different from those of the above embodiment will be mainly described, and detailed description of points common to those already described will be omitted. In addition, the modifications to be described below may be implemented individually or in combination as appropriate.

(Modification 1)

In the embodiment described above, the mode in the case where each user who participates in a remote drinking party uses a different restaurant 50 and a different restaurant terminal 10 has been described. However, the mode of the remote drinking party is not limited to the above case, and the server device 30 described above can similarly handle the case where a plurality of users use the same restaurant 50 and the same restaurant terminal 10.

Specifically, when the reservation receiving unit 311 of the processor 31 of the server device 30 receives a reservation in which the same restaurant ID is designated from users having different user IDs, the reservation receiving unit 311 manages the user IDs of those users in association with the same restaurant ID.

Further, when receiving a plurality of user IDs from the restaurant terminal 10 having the same terminal ID, the inter-terminal communication unit 312 of the processor 31 of the server device 30 registers the plurality of user IDs in the reservation information in association with the same terminal ID.

Further, for example, when receiving an operation of the second operation button 1152, the GUI providing unit 313 of the processor 31 of the server device 30 causes the display device 16 of the restaurant terminal 10, on which the above-mentioned operation is performed, to display a common menu item screen 200 on which the presence of a plurality of users in the same restaurant 50 can be confirmed.

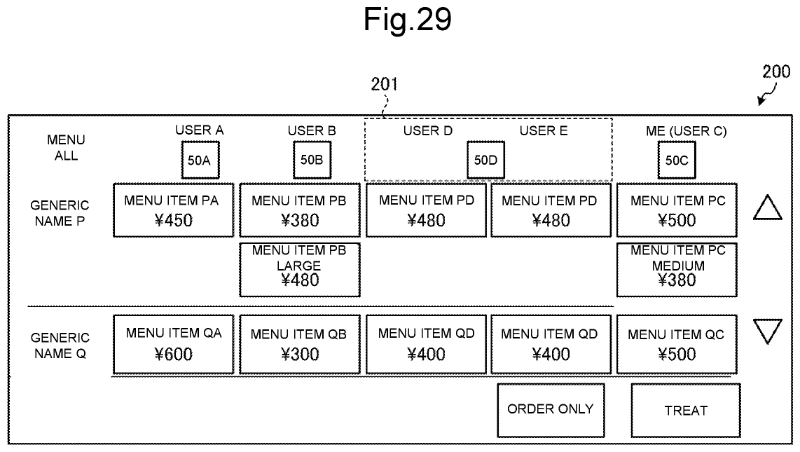

FIG. 29 is a diagram showing an example of a screen displayed on the restaurant terminal 10 according to this modification. FIG. 29 shows a display example of the common menu item screen 200. As shown in FIG. 29, the common menu item screen 200 has a screen configuration similar to that of the common menu item screen 130 described above. Further, the common menu item screen 200 shows that a user D and a user E being in the same restaurant 50 (restaurant 50D) are surrounded by a broken line 201, which represents that both the users are in the same restaurant.

Note that the order method for the user D and the user E is not particularly limited. For example, when the user D or the user E orders a menu item, the GUI providing unit 313 of the processor 31 may cause the display device 16 of the restaurant terminal 10 to display a screen for selecting which of the user D and the user E is the order destination (order source). Further, for example, when a menu item to be ordered is selected for the user ID of a user other than the user D and the user E, the GUI providing unit 313 may cause the display device 16 of the restaurant terminal 10 to display a screen for selecting which of the user D and the user E is the order source.

Further, for example, when receiving an operation of the checkout button 1153, the checkout processing unit 315 of the processor 31 of the server device 30 causes the display device 16 of the restaurant terminal 10 operated by each user to display a checkout screen 210 on which the presence of a plurality of users in the same restaurant 50 can be confirmed.

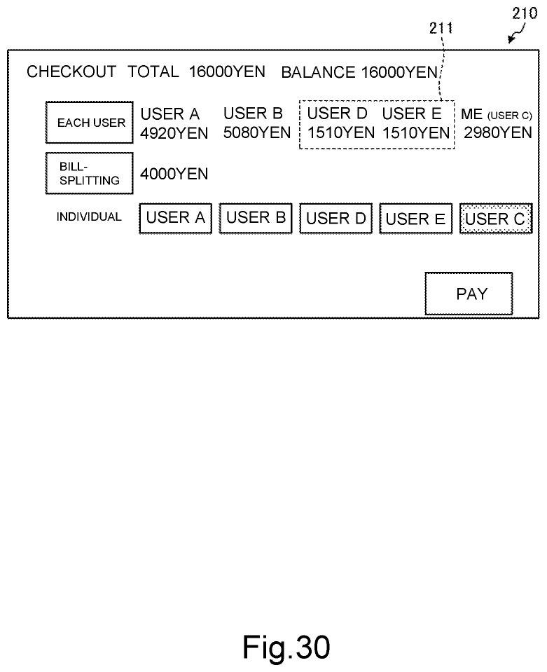

FIG. 30 is a diagram showing another example of a screen displayed on the restaurant terminal 10 according to this modification. FIG. 30 shows a display example of the checkout screen 210. As shown in FIG. 30, the checkout screen 210 has a screen configuration similar to that of the checkout screen 170 described above. Further, the checkout screen 210 shows that the user D and the user E being in the same restaurant 50 (restaurant 50D) are surrounded by a broken line 211, which represents that both the users are in the same restaurant 50. Note that the checkout processing is the same as in the embodiment described above, and thus description thereof will be omitted.

As described above, even when a plurality of users use the same restaurant 50, the server device 30 according to this modification can produce the same effects as in the embodiment described above.

(Modification 2)

In the embodiment described above, the mode in the case where a remote eating and drinking proving service (remote drinking party) is performed using the restaurant terminal 10 of the restaurant 50 has been described, but the embodiment is not limited to the restaurant terminal 10. For example, the user terminal 20 may be used. In this case, for example, the user terminal 20 is connected to the server device 30 in the restaurant 50 and thus functions as an input/output interface of the server device 30 in the same manner as the restaurant terminal 10 described above.

As a result, the same effects as in the embodiment described above can be produced. Therefore, even when the user terminal 20 is used, the convenience related to the remote eating and drinking proving service using a plurality of restaurants can be improved.

Note that the program executed by each device of the embodiments described above is provided by being incorporated in advance in a ROM, a storage device, or the like. The program executed by each device of the embodiments described above may be recorded on a computer readable recording medium such as a CD-ROM, a flexible disk (FD), a CD-R, or a digital versatile disc (DVD) in a file of an installable or executable format, and then provided.

Furthermore, the program executed by each device of the embodiments described above may be stored in a computer connected to a network such as the Internet and then provided by downloading over a network. Further, the program executed by each device of the embodiments described above may be provided or distributed over a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device, which provides a remote eating and drinking service allowing a conversation and screen sharing between users using a plurality of different restaurants, the server device comprising:
a communication device that communicates with terminals belonging to the plurality of restaurants and operated by the users;
a reservation management table that registers reservation information in association with reservation identification information, the reservation identification information being information for identifying a reservation for receiving the service, the reservation information including user identification information for identifying a user who receives the service, restaurant identification information for identifying a restaurant used by the user, and terminal identification information for identifying a terminal belonging to the restaurant used by the user; and
a processor configured to
receive access in which participation information is designated from each of the terminals via the communication device, the participation information including at least the reservation identification information,
specify the reservation information associated with the reservation identification information included in the participation information from the reservation management table,
connect the terminals identified by the terminal identification information included in the specified reservation information to each other in a communicable manner,
provide menu information of menu items for eating and drinking that can be provided in the restaurant identified by the restaurant identification information included in the specified reservation information to the connected terminals such that the menu information can be browsed on the connected terminals, and
receive an order of a menu item for eating and drinking from any one of the terminals provided with the menu information via the communication device and notify the restaurant that provides the menu item for eating and drinking of information regarding the ordered menu item for eating and drinking.

2. The server device according to claim 1, wherein
the participation information further includes the user identification information, and
the processor performs processing of determining whether or not the specified reservation information includes the user identification information included in the participation information.

3. The server device according to claim 2, wherein
the processor additionally registers, if the specified reservation information does not include the user identification information included in the participation information, the terminal identification information of a source terminal of the access and the restaurant identification information of a restaurant to which the source terminal belongs in the reservation management table in association with the reservation identification information included in the participation information.

4. The server device according to claim 1, wherein
the processor extracts menu information of a common menu item for eating and drinking from the menu information of menu items for eating and drinking that can be provided in each of the plurality of restaurants identified by the restaurant identification information included in the specified reservation information, and provides the extracted menu information of the menu item for eating and drinking to the terminals such that the extracted menu information can be browsed on the terminals.

5. The server device according to claim 1, wherein
the processor specifies, each time the order of the menu item for eating and drinking is received, an order-source user who operates the terminal on which the order has been performed and an order-destination user to whom the ordered menu item for eating and drinking is to be provided.

6. The server device according to claim 5, wherein
the processor provides, if the specified order-source user and the specified order-destination user are different from each other, confirmation information for confirming order contents to the terminal or terminals operated by one or both of the order-source user and the order-destination user.

7. The server device according to claim 1, wherein
the processor performs checkout processing of paying for the ordered menu item for eating and drinking to the restaurant that provides the menu item for eating and drinking.

8. The server device according to claim 7, wherein
the processor performs the checkout processing on a basis of a payment amount obtained by dividing a price of the menu items for eating and drinking by the number of users identified by the user identification information included in the specified reservation information.

9. The server device according to claim 8, wherein
the processor performs the checkout processing on a basis of a payment amount individually designated by any user of the users identified by the user identification information included in the specified reservation information.

10. A method of controlling a server device that provides a remote eating and drinking service allowing a conversation and screen sharing between users using a plurality of different restaurants, the method comprising:
registering reservation information in a reservation management table in association with reservation identification information, the reservation identification information being information for identifying a reservation for receiving the service, the reservation information including user identification information for identifying a user who receives the service, restaurant identification information for identifying a restaurant used by the user, and terminal identification information for identifying a terminal belonging to the restaurant used by the user;
receiving access in which participation information is designated from each of the terminals via a communication device, the participation information including at least the reservation identification information;
specifying the reservation information associated with the reservation identification information included in the participation information from the reservation management table;
connecting the terminals identified by the terminal identification information included in the specified reservation information to each other in a communicable manner;
providing menu information of menu items for eating and drinking that can be provided in the restaurant identified by the restaurant identification information included in the specified reservation information to the terminals connected to each other in the communicable manner such that the menu information can be browsed on the connected terminals; and
receiving an order of a menu item for eating and drinking from any one of the terminals provided with the menu information via the communication device and notifying the restaurant that provides the menu item for eating and drinking of information regarding the ordered menu item for eating and drinking.
